(19) United States
(12) Patent Application Publication
(10) Pub. No.: US 2026/0252616 A1
(43) Pub. Date: Aug. 27, 2026

(54) SYSTEM

(71) Applicant: SoftBank Group Corp., Tokyo (JP)

(72) Inventor: Yasufumi HIRAI, Tokyo (JP)

(73) Assignee: SoftBank Group Corp., Tokyo (JP)

(21) Appl. No.: 19/536,315

(22) Filed: Feb. 11, 2026

(30) Foreign Application Priority Data
Feb. 21, 2025 (JP) 2025-027088

(51) Int. Cl. G06F 16/34; G06F 21/31; G06F 21/32; G06N 3/08; G06V 40/12

(52) U.S. Cl. CPC G06F 16/345; G06F 21/31; G06F 21/316; G06F 21/32; G06N 3/08; G06V 40/12

(57) ABSTRACT

The system according to the embodiment comprises a fingerprint authentication unit, a summarization unit, a browsing unit, an image browsing unit, a sharing unit, an external microphone, and a camera unit. The fingerprint authentication unit individually identifies a user. The summarization unit summarizes text written by the user with a pen. The browsing unit allows the summarized text by the summarization unit to be browsed with a dedicated application. The image browsing unit allows drawn images to be browsed with a dedicated application. The sharing unit shares text or images written or drawn by other users. The external microphone records audio. The camera unit records images.

### CROSS-REFERENCE TO RELATED APPLICATION

The present application claims priority to and incorporates by reference the entire contents of Japanese Patent Application No. 2025-027088 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to efficiently manage and share the copyright of text written or images drawn by users.

### SUMMARY OF THE INVENTION

The system according to the embodiment comprises a fingerprint authentication unit, a summarization unit, a browsing unit, an image browsing unit, a sharing unit, an external microphone, and a camera unit. The fingerprint authentication unit individually identifies a user. The summarization unit summarizes text written by the user with a pen. The browsing unit allows the summarized text by the summarization unit to be browsed with a dedicated application. The image browsing unit allows drawn images to be browsed with a dedicated application. The sharing unit shares text or images written or drawn by other users. The external microphone records audio. The camera unit records images.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

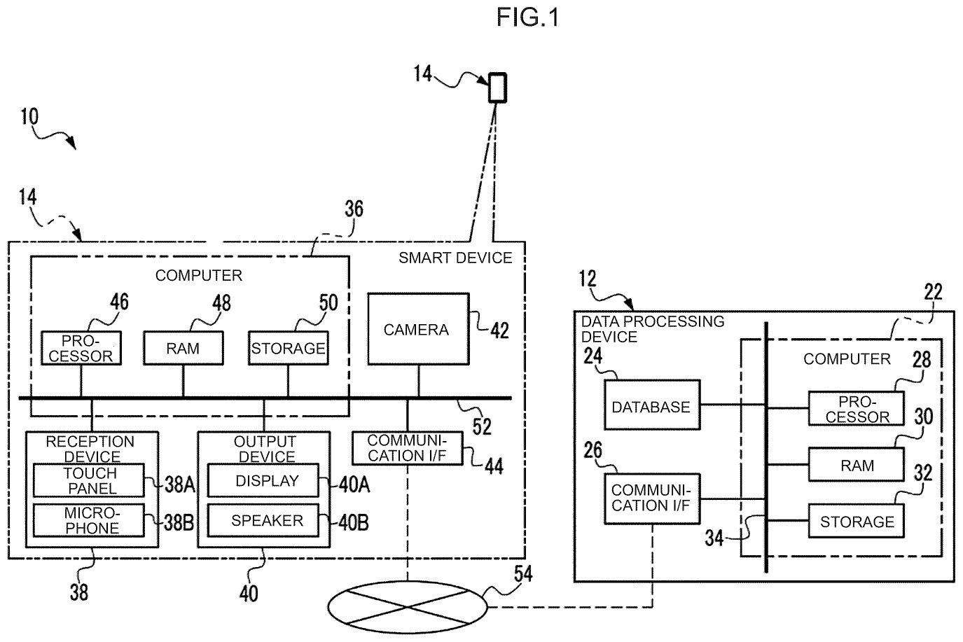

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

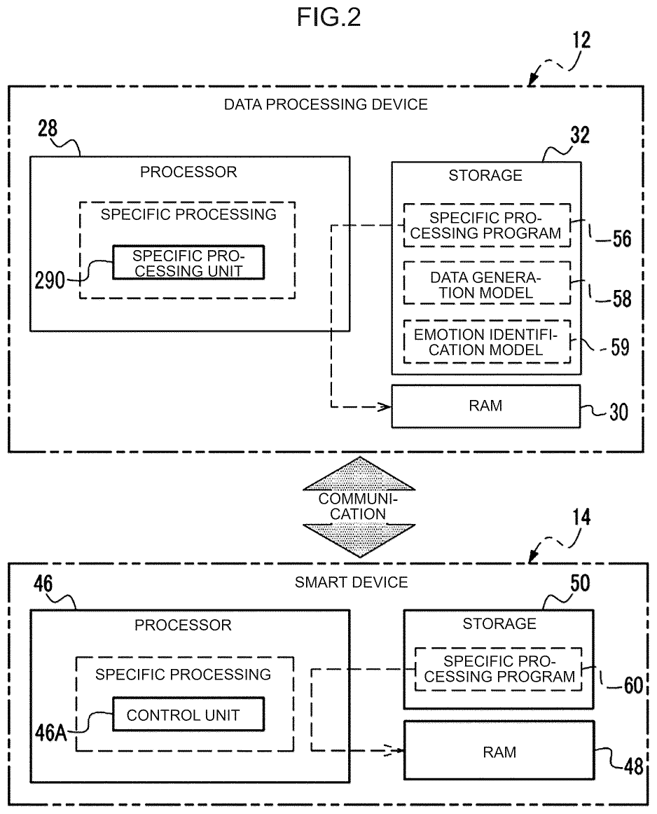

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The pen-type device system according to the embodiment of the present invention is a system for protecting the copyright of text written and images drawn by the user. This system is equipped with a fingerprint authentication function for individual identification of the user, automatically summarizes text written by the user with a pen using AI, and makes it viewable in the iPentity application. Drawn images can also be viewed in the iPentity application, and text or images written or drawn by other users can be shared. Furthermore, the device is equipped with an external microphone and camera function, allowing audio and images to be recorded. Copyright protection is achieved by assigning a timestamp to digital data generated by the device and associating it with the user's fingerprint information. This enables confirmation of who created what and when. Thus, the pen-type device system protects the copyright of the user's creations and enables individual identification, summarization, browsing, sharing, recording, and capturing. Specifically, the pen-type device system digitizes character information written by the user with a pen and image information drawn by the user with high accuracy using built-in sensor groups (pressure sensors, accelerometers, touch sensors, etc.) and the camera unit, and records these data as time-series tensors (e.g., stroke coordinate sequences, pressure value arrays, image pixel matrices). The system acquires biometric information (fingerprint image data: e.g., 256×256 pixel grayscale images) of the user via the fingerprint authentication unit, extracts feature vectors using a feature extraction algorithm (e.g., convolutional neural network), and stores them in a database linked to the user ID. The summarization unit uses a large-scale language model (e.g., Transformer architecture with billions of parameters) to generate summary sentences (e.g., “Record of new ideas,” “Landscape painting”) as output, given text data of sentences written by the user (e.g., “I came up with a new idea today”) or caption information extracted from images (e.g., “A picture of a blue sky and trees”) as input. Examples of AI input include (1) text strings after handwriting recognition (UTF-8 encoding), (2) image tensors for image caption generation (3×224×224), and (3) text data after speech recognition. Examples of AI output include (1) summary sentences (e.g., “Minutes of the meeting”), (2) tagging information (e.g., “Portrait,” “Landscape”), and (3) confidence scores (e.g., 0.92). These outputs are sent to the browsing unit and sharing unit, allowing users and others to easily access, search, and browse via the dedicated application. Furthermore, the external microphone acquires audio waveform data (16 kHz, 16 bit PCM) in real time, converts it to text using a speech recognition AI (e.g., RNN-based speech recognition model), and, if necessary, sends it to the summarization unit for summary sentence generation. The camera unit acquires image data (JPEG/PNG, etc.) and performs content analysis and tagging using image recognition AI. For copyright protection, the device assigns a high-precision timestamp (UNIX epoch seconds, etc.) obtained from the hardware clock to all generated data and records it in a blockchain-type ledger or secure database, irreversibly associated with the user ID (fingerprint feature vector). This prevents data tampering and impersonation at a later date and technically proves who created what and when. Unlike conventional manual work or simple electronic signature methods, this system executes AI-based automatic summarization, classification, tagging, biometric authentication, timestamp assignment, and database linkage as a series of rule-based processes quickly and with high accuracy, dramatically improving the reliability, evidentiality, and searchability of copyright protection. Application fields include management of students' creative works in educational settings, copyright proof for digital art, automatic summarization and trace management of business documents, tamper prevention for research notes, and distribution management of creators' works. Technical effects include (1) significant improvement in data management and search efficiency through AI-based automatic summarization and classification, (2) increased reliability of copyright proof through biometric authentication and timestamp assignment, (3) integrated management of multimodal data such as audio, images, and text, and (4) simultaneous improvement of user experience and prevention of unauthorized use. These configurations and processes are not merely automation of human work, but realize the advancement of computer technology itself by combining AI, sensors, databases, and security technologies.

The pen-type device system according to the embodiment comprises a fingerprint authentication unit, a summarization unit, a browsing unit, an image browsing unit, a sharing unit, an external microphone, and a camera unit. The fingerprint authentication unit individually identifies the user. For example, the fingerprint authentication unit reads the user's fingerprint using a fingerprint sensor and performs individual identification. The fingerprint authentication unit stores fingerprint data within the device and performs individual identification by matching during authentication. The summarization unit uses generative AI to automatically summarize text written by the user with a pen. For example, the summarization unit uses a text generation AI (e.g., LLM) to concisely summarize sentences. The summarization unit can also use generative AI to extract important parts of the text and summarize them. The browsing unit enables summarized text to be browsed with the iPentity application. For example, the browsing unit sends summarized text to the dedicated application, allowing the user to browse it through the application. The image browsing unit enables drawn images to be browsed with the iPentity application. For example, the image browsing unit saves drawn images as digital data and sends them to the dedicated application, allowing the user to browse them through the application. The sharing unit shares text or images written or drawn by other users. For example, the sharing unit shares text or images written or drawn by other users through the dedicated application, allowing the user to browse them. The external microphone is used for recording voice memos by the user. For example, the external microphone records audio using a built-in microphone in the device and saves it as digital data. The camera unit captures images of drawings or text written by the user and saves them as digital data. For example, the camera unit captures images using a built-in camera in the device and saves them as digital data. Thus, the pen-type device system according to the embodiment protects the copyright of the user's creations and enables individual identification, summarization, browsing, sharing, recording, and capturing. Specifically, the pen-type device system supports the user's creative activities in multiple aspects by having each component work in coordination, greatly improving the reliability, manageability, and searchability of data. The fingerprint authentication unit converts fingerprint images (e.g., 256×256 pixels) obtained from fingerprint sensors (e.g., capacitive, optical, ultrasonic) into feature vectors using a convolutional neural network (CNN) feature extraction model and stores them in a database linked to the user ID. During authentication, feature vectors are similarly extracted from input fingerprint images and matched with the existing database using cosine similarity, etc. The summarization unit uses a Transformer-based large-scale language model (e.g., 12 layers, over 100 million parameters), receives handwritten text data (e.g., “Today's minutes”) or text data after speech recognition as input, and generates summary sentences (e.g., “Meeting highlights”) or lists of important keywords (e.g., “Decisions,” “Issues”) as output. The browsing unit sends summary sentences and tag information output from the summarization unit to the database of the dedicated application, enabling list display, search, and filtering on the user interface. The image browsing unit classifies and tags image data (e.g., PNG format, 1024×768 pixels) obtained from the camera unit or pen coordinate sensor using image recognition AI, sends it to the dedicated application, and enables thumbnail and enlarged display. The sharing unit distributes user-authorized text and image data to other users' applications via a secure communication channel (TLS, etc.), and manages access rights and history. The external microphone acquires audio waveform data (16 kHz, 16 bit, etc.) in real time, converts it to text using speech recognition AI (e.g., RNN, Transformer), and sends it to the summarization unit and browsing unit. The camera unit acquires image data, analyzes content and tags using image recognition AI, and stores it in the database. These components realize an advanced information processing infrastructure by combining AI, sensors, databases, and security technologies, not merely automating human work, and simultaneously achieve copyright protection, data management, and improved user experience. Technical effects include (1) improved data search and management efficiency through AI-based automatic summarization, classification, and tagging, (2) prevention of unauthorized use and impersonation through biometric authentication and secure communication, (3) integrated management of multimodal data (text, images, audio), and (4) easy management of user-specific access rights and history. Application fields include management of student works in educational settings, trace management of business documents, copyright proof for creators, tamper prevention for research notes, and distribution management of digital art.

The summarization unit can automatically summarize text written by the user with a pen. For example, the summarization unit uses generative AI to automatically summarize text written by the user with a pen. The summarization unit uses a text generation AI (e.g., LLM) to concisely summarize sentences. The summarization unit can also use generative AI to extract important parts of the text and summarize them. For example, the summarization unit performs summarization based on the length of the text and the importance of the information to be summarized. The summarization unit inputs a prompt such as “Please summarize the main points of this text” to the generative AI, which extracts the main points and generates a summary. By automatically summarizing text written by the user with a pen, efficient management of text is achieved. Specifically, the summarization unit extracts text data (e.g., “I came up with a new idea today”) from pen input using a handwriting recognition engine (e.g., convolutional neural network-based OCR) and inputs it to a large-scale language model (e.g., 12-layer Transformer, over 100 million parameters). AI input data includes (1) text strings after handwriting recognition (UTF-8 encoding, up to 512 tokens), and (2) text metadata (creation date, user ID, tag information, etc.). The AI uses an attention mechanism to extract important keywords and topics from the input text and outputs summary sentences (e.g., “Record of new ideas”) and keyword lists (e.g., “Idea,” “Inspiration”). Output formats include (1) summary sentences (up to 100 characters), (2) lists of important keywords (up to 5 items), and (3) confidence scores (e.g., 0.95). For example, if the input is “I came up with a new idea today. Details will be summarized later,” the output would be “Record of new ideas,” “Idea,” “0.97,” etc. The AI output is sent to subsequent browsing and sharing units, allowing users to easily search and browse via the dedicated application. The summarization unit automatically adjusts the level of detail and the number of extracted keywords according to the length (number of tokens) and importance (TF-IDF score, etc.) of the text. Furthermore, the summarization unit combines multiple summarization algorithms (extractive summarization, generative summarization, keyword extraction, etc.) and automatically selects the optimal summarization method according to the category of the text (technical documents, diaries, minutes, etc.). Unlike conventional simple text shortening or manual summarization, the AI performs feature extraction, weighting, and rule-based processing in high-dimensional space, greatly improving summarization accuracy, consistency, and reproducibility. Technical effects include (1) improved data management and search efficiency by automatically summarizing and classifying large amounts of handwritten text, (2) the ability to eliminate overlooked important information and redundant descriptions, and (3) the ability to generate optimized summaries for each user. Application fields include note summarization in educational settings, automatic summarization of business minutes, extraction of key points from research notes, and summarization functions in diary applications.

The browsing unit enables summarized text to be browsed with the iPentity application. For example, the browsing unit enables summarized text to be browsed with the iPentity application. The browsing unit sends summarized text to the dedicated application, allowing the user to browse it through the application. For example, the browsing unit saves summarized text as digital data and sends it to the dedicated application. The user can browse summarized text through the iPentity application. By enabling summarized text to be browsed with the iPentity application, users can easily access it. Specifically, the browsing unit stores summary text data (e.g., UTF-8 encoded text, up to 100 characters), tag information (e.g., “Meeting,” “Idea”), and confidence scores (e.g., 0.95) received from the summarization unit in the storage area of the dedicated application's database management module. The browsing unit manages access rights for each user and generates a list of browsable summary texts based on the user ID (linked to the feature vector generated by the fingerprint authentication unit). The browsing unit is equipped with a user interface module that provides functions such as list display of summary texts, full text display, filtering by tags, response to search queries (e.g., “Minutes of June 2024”), and sorting (by creation date, importance, etc.). Furthermore, the browsing unit adds metadata (creation date, creator ID, related image ID, etc.) to the summary text and dynamically generates links to related original text, images, and audio data when the user selects a summary text. Examples of AI-generated summary text output include “Record of new ideas,” “Meeting highlights,” etc., with tag information such as “Technology,” “Minutes.” These outputs are stored in the browsing unit's database and are retrieved and displayed in real time when the user opens the “Summary List” screen in the dedicated application. The browsing unit uses index search and caching mechanisms to achieve fast response when retrieving data from the database, minimizing search and display delays even when thousands of summary texts are accumulated. Furthermore, the browsing unit records the user's browsing history (e.g., the last 30 browsed summary IDs, browsing frequency, etc.) and works with a personalized recommendation module to preferentially display highly relevant or popular summary texts. Technical effects include (1) efficient search and browsing of vast amounts of text data through database management linked with AI-based automatic summarization, (2) secure and personalized information provision through user-specific access rights management and history analysis, and (3) greatly improved response speed and user experience through the introduction of index search and caching mechanisms. Application fields include note summary browsing in educational settings, search and reference of business minutes, trace management of research notes, and summary browsing of creators' works. The configuration and processing of the browsing unit realize the advancement of computer technology by combining AI, databases, and user interface technologies, not merely automating human work.

The image browsing unit enables drawn images to be browsed with the iPentity application. For example, the image browsing unit enables drawn images to be browsed with the iPentity application. The image browsing unit saves drawn images as digital data and sends them to the dedicated application, allowing the user to browse them through the application. For example, the image browsing unit saves drawn images as digital data and sends them to the dedicated application. The user can browse drawn images through the iPentity application. By enabling drawn images to be browsed with the iPentity application, users can easily access them. Specifically, the image browsing unit analyzes and tags image data (e.g., PNG format, 1024×768 pixels, 24-bit color) obtained from the camera unit or pen coordinate sensor using image recognition AI (e.g., ResNet-based CNN with over 50 million parameters) and stores it in the image database. The image browsing unit manages access rights for image data for each user ID (linked to the feature vector generated by the fingerprint authentication unit) and generates and displays thumbnail images (e.g., 128×96 pixels) quickly when the user opens the “Image List” screen in the dedicated application. Furthermore, the image browsing unit adds image metadata (creation date, tags, related summary text ID, etc.) and dynamically generates links to enlarged display, related summary text, and voice memos when the user selects an image. Examples of AI input for image analysis include (1) image tensors captured by the camera unit (3×1024×768), (2) stroke data from the pen coordinate sensor (time-series coordinate arrays), and (3) image data for image caption generation. Examples of AI output include (1) image category labels (e.g., “Landscape painting”), (2) tag lists (e.g., “Blue sky,” “Tree”), and (3) confidence scores (e.g., 0.93). These outputs are stored in the image browsing unit's database and are used when the user searches and browses images in the dedicated application, providing functions such as filtering by tags and categories, sorting (by creation date, popularity, etc.), thumbnail display, and enlarged display. Furthermore, the image browsing unit records the user's browsing history and image browsing frequency and works with a personalized recommendation module to preferentially display highly relevant or popular images. Technical effects include (1) efficient search and browsing of vast amounts of image data through database management linked with AI-based image analysis and tagging, (2) secure and personalized image provision through user-specific access rights management and history analysis, and (3) greatly improved response speed and user experience through the introduction of thumbnail generation and index search. Application fields include management of student works in educational settings, browsing and distribution of digital art, management of creators' works, and management of illustrations in research notes. The configuration and processing of the image browsing unit realize the advancement of computer technology by combining AI, image recognition, databases, and user interface technologies, not merely automating human work.

The sharing unit enables text or images written or drawn by other users to be shared. For example, the sharing unit shares text or images written or drawn by other users. The sharing unit shares text or images written or drawn by other users through the dedicated application, allowing the user to browse them. For example, the sharing unit saves text or images written or drawn by other users as digital data and sends them to the dedicated application. The user can browse text or images written or drawn by other users through the iPentity application. By sharing text or images written or drawn by other users, information sharing becomes easier. Specifically, the sharing unit distributes summary text data and image data received from the summarization unit and image browsing unit to other users' dedicated applications via a secure communication channel (e.g., TLS encryption). The sharing unit manages access rights (public, limited, private, etc.) and sharing scope (group unit, individual user specification, etc.) for each user, and records sharing history (sharing date, recipient ID, number of accesses, etc.) in the database. The sharing unit adds metadata (creator ID, creation date, tags, related summary ID, etc.) to the shared data, enabling the recipient user to retrieve and display it in real time when opening the “Shared Content List” screen in the dedicated application. An AI-based sharing recommendation function can also be implemented, analyzing the user's browsing history, tag information, and past sharing trends to automatically suggest highly relevant summary texts or images as sharing candidates. Examples of AI input include (1) user browsing history vectors (the last 50 summary IDs and image IDs), (2) tag information vectors (e.g., “Technology,” “Landscape”), and (3) sharing history data. Examples of AI output include (1) sharing recommendation lists (lists of summary IDs and image IDs), (2) sharing priority scores (e.g., 0.85), and (3) candidate recipient lists (user IDs). These outputs are presented to the user via the sharing unit interface, and when the user approves sharing, data is distributed via a secure communication channel. Furthermore, the sharing unit can assign hash values and timestamps to shared data to prevent tampering and record them in a blockchain-type ledger or secure database. Technical effects include (1) efficient and secure information sharing through the combination of AI-based sharing recommendations, secure communication, and history management, (2) prevention of unauthorized use and impersonation through user-specific access rights and sharing history management, and (3) improved copyright protection and reliability through tamper prevention and trace management of shared data. Application fields include sharing of student works in educational settings, collaborative editing of business documents, distribution of creators' works, and joint management of research notes. The configuration and processing of the sharing unit realize the advancement of computer technology by combining AI, security, databases, and communication technologies, not merely automating human work.

The external microphone can be used for recording voice memos by the user. For example, the external microphone is used for recording voice memos by the user. The external microphone records audio using a built-in microphone in the device and saves it as digital data. For example, the external microphone records voice memos by the user and saves them as digital data. The user can play back and edit the recorded voice memos as needed. By recording voice memos, audio information can be recorded. Specifically, the external microphone acquires audio waveform data in real time in 16 kHz, 16 bit PCM format and saves it in the device's internal storage in WAV or FLAC format via a recording control module. The external microphone receives control signals for starting, stopping, and pausing recording from the user interface, performs buffering during recording, and prevents data loss and noise contamination. Furthermore, after recording, the external microphone sends the audio data to a speech recognition AI (e.g., RNN or Transformer-based speech recognition model with over 10 million parameters) to generate text data (e.g., “Minutes of the meeting”). Examples of AI input include (1) audio waveform tensors (1×16000×seconds), and (2) recording metadata (recording date, user ID, etc.). Examples of AI output include (1) transcribed audio content (e.g., “Talked about new ideas”), and (2) confidence scores (e.g., 0.92). These outputs are sent to the summarization unit and browsing unit and used for summary sentence generation and searching/browsing of voice memos. The external microphone automatically performs preprocessing such as noise reduction and volume normalization on the recorded data to improve speech recognition accuracy. Furthermore, the user can play back and edit (trimming, splitting, tagging, etc.) recorded voice memos in the dedicated application. Technical effects include (1) easy transcription, summarization, and searching of voice memos through linkage with high-accuracy speech recognition AI, (2) improved recording quality and recognition accuracy through automatic preprocessing such as noise reduction and volume normalization, and (3) improved user experience through digital management and editing functions of recorded data. Application fields include audio recording of meeting minutes, voice input for diary applications, management of voice memos in research notes, and recording of presentations in educational settings. The configuration and processing of the external microphone realize the advancement of computer technology by combining AI, speech recognition, databases, and user interface technologies, not merely automating human work.

The camera unit can capture images of drawings or text written by the user and save them as digital data. For example, the camera unit captures images of drawings or text written by the user and saves them as digital data. The camera unit captures images using a built-in camera in the device and saves them as digital data. For example, the camera unit captures images of drawings or text written by the user and saves them as digital data. The user can browse and edit the captured images through the dedicated application as needed. By saving drawings or text written by the user as digital data, data management becomes easier. Specifically, the camera unit is equipped with a CMOS sensor of 8 megapixels or more and acquires image data (e.g., 1024×768 pixels, 24-bit color) in JPEG or PNG format. The camera unit performs real-time image processing such as auto exposure, white balance, and image stabilization during shooting to optimize image quality. The captured image data is sent to image recognition AI (e.g., ResNet or EfficientNet-based CNN with over 50 million parameters) for content analysis (e.g., text area detection, shape recognition, color analysis) and tagging (e.g., “Landscape painting,” “Minutes”). Examples of AI input include (1) image tensors (3×1024×768), and (2) shooting metadata (shooting date, user ID, etc.). Examples of AI output include (1) image category labels (e.g., “Portrait”), (2) tag lists (e.g., “Blue sky,” “Tree”), and (3) confidence scores (e.g., 0.94). These outputs are stored in the image browsing unit and database and used when the user searches, browses, and edits images (trimming, rotation, color correction, etc.) in the dedicated application. The camera unit can assign hash values and timestamps to image data and record them in a secure database or blockchain-type ledger for copyright protection and tamper prevention. Technical effects include (1) easy automatic classification, tagging, and searching of image data through linkage with high-accuracy image recognition AI, (2) improved shooting quality and recognition accuracy through automatic image processing functions, and (3) improved user experience through digital management and editing functions of image data. Application fields include shooting and management of works in educational settings, image recording of business documents, management of creators' works, and management of illustrations in research notes. The configuration and processing of the camera unit realize the advancement of computer technology by combining AI, image recognition, databases, and user interface technologies, not merely automating human work.

Copyright can be protected by assigning a timestamp to digital data generated by the device and associating it with the user's fingerprint information. Copyright is protected by assigning a timestamp to digital data generated by the device and associating it with the user's fingerprint information. The timestamp records, for example, the date and time when the digital data was generated. The timestamp is assigned to the digital data and associated with the user's fingerprint information. This enables confirmation of who created what and when. For example, the device saves text written by the user with a pen or images drawn as digital data and assigns a timestamp to the data. The timestamp records the generation date and time of the digital data and is associated with the user's fingerprint information. This enables protection of the copyright of digital data. Specifically, the device automatically assigns a high-precision timestamp (e.g., UNIX epoch seconds, millisecond units) obtained from the hardware clock to all generated data (summary sentences, images, audio, tag information, etc.). The timestamp assignment module irreversibly associates the timestamp with the user ID (feature vector generated by the fingerprint authentication unit) at the time of data generation and records it in a database or blockchain-type ledger. The association of the timestamp and fingerprint information uses hash functions (e.g., SHA-256) or electronic signature algorithms (e.g., RSA, ECDSA) to prevent data tampering and impersonation. For example, when text written with a pen is summarized by the summarization unit, the summary text data (UTF-8 text), generation date and time (timestamp), user ID (fingerprint feature vector), and hash value (SHA-256 value of the entire data) are recorded together. The same applies to image data, with shooting date and time, user ID, and hash value assigned and stored in a secure database. This enables technical proof of who created what and when, even if data tampering or impersonation occurs later, by verifying the timestamp and fingerprint information. By executing AI-based automatic summarization, classification, tagging, biometric authentication, timestamp assignment, and database linkage as a series of rule-based processes quickly and with high accuracy, the reliability, evidentiality, and searchability of copyright protection are dramatically improved. Technical effects include (1) greatly improved reliability and evidentiality of copyright proof through irreversible association of timestamps and biometric authentication information, (2) prevention of data tampering and impersonation, and (3) improved searchability and manageability through linkage with databases and blockchain-type ledgers. Application fields include copyright proof for student works in educational settings, distribution management of digital art, trace management of business documents, tamper prevention for research notes, and distribution management of creators' works. The configuration and processing of the device realize the advancement of computer technology by combining AI, sensors, databases, and security technologies, not merely automating human work.

The fingerprint authentication unit can estimate the user's emotion and adjust the accuracy of fingerprint authentication based on the estimated emotion of the user. For example, the fingerprint authentication unit estimates the user's emotion and adjusts the accuracy of fingerprint authentication based on the estimated emotion. The fingerprint authentication unit estimates the user's emotion using an emotion estimation algorithm. For example, if the user is nervous, the fingerprint authentication unit increases the accuracy to prevent false authentication. If the user is relaxed, the fingerprint authentication unit can return the accuracy to normal. Furthermore, if the user is in a hurry, the fingerprint authentication unit can slightly relax the accuracy to increase authentication speed. By adjusting the accuracy of fingerprint authentication based on the user's emotion, authentication accuracy is improved. Emotion estimation is realized using, for example, an emotion engine or generative AI with emotion estimation functions. Generative AI includes text generation AI (e.g., LLM) and multimodal generative AI, but is not limited to these examples. Specifically, the fingerprint authentication unit uses a multimodal AI model (e.g., Transformer architecture integrating image, audio, and text inputs, with over 100 million parameters) for user emotion estimation. The fingerprint authentication unit acquires as input (1) biometric signals during fingerprint authentication (e.g., skin conductance values, heart rate, fingertip temperature as time-series vectors), (2) user audio data (e.g., speech waveform tensor, 1×16000×seconds), and (3) user facial images (e.g., face images acquired by the camera unit, 3×224×224 pixels), preprocesses these (noise removal, normalization, feature extraction), and inputs them to the AI model. The AI model extracts feature vectors from each input data and outputs emotion labels such as “nervous,” “relaxed,” “in a hurry” (e.g., one-hot vectors, probability distributions [0.7, 0.2, 0.1]) using attention mechanisms and multi-head classifiers. Output examples include (1) emotion label “nervous”+confidence 0.85, (2) emotion label “relaxed”+confidence 0.92, (3) emotion label “in a hurry”+confidence 0.78. The fingerprint authentication unit automatically adjusts the threshold of the fingerprint authentication algorithm (e.g., cosine similarity threshold strengthened from 0.85 to 0.90, relaxed from 0.85 to 0.80) and the number of matching attempts (e.g., whether to perform multiple matches) according to the AI output. For example, if a nervous state is estimated, the threshold is made stricter; for a relaxed state, normal settings are used; for a hurried state, the threshold is relaxed to prioritize authentication speed. Thus, the fingerprint authentication unit can optimize the balance between authentication accuracy and convenience according to the user's biometric state and emotional fluctuations. Unlike conventional simple biometric authentication, this configuration combines AI-based high-dimensional feature extraction, multimodal inference, and rule-based control to simultaneously achieve reduced false authentication rates, improved authentication experience, and enhanced security. Application fields include high-security authentication terminals for financial institutions, exam authentication in educational settings, access control in medical settings, and creator work management systems. Technical effects include (1) dynamic authentication accuracy control according to the user's emotional state, reducing false authentication and impersonation risks, (2) greatly improved adaptability and flexibility of biometric authentication through AI-based multimodal emotion estimation, and (3) simultaneous personalization of authentication experience and security enhancement. The configuration and processing of the fingerprint authentication unit realize the advancement of computer technology by integrating AI, biometric sensors, multimodal inference, and authentication algorithm control, not merely automating human work.

The fingerprint authentication unit can refer to the user's past authentication history during fingerprint authentication and adjust the authentication speed. For example, the fingerprint authentication unit refers to the user's past authentication history during fingerprint authentication and adjusts the authentication speed. The fingerprint authentication unit stores past authentication history in a database and refers to it during authentication to optimize authentication speed. For example, if the user has frequently succeeded in authentication in the past, the fingerprint authentication unit increases the authentication speed. If the user has frequently failed authentication in the past, the fingerprint authentication unit can decrease the speed and increase accuracy. Furthermore, the fingerprint authentication unit can analyze the user's authentication history and automatically set the optimal authentication speed. By referring to the user's past authentication history, authentication speed can be optimized. Specifically, the fingerprint authentication unit manages an authentication history database for each user (e.g., structured tables including authentication date and time, success/failure flags, authentication duration, failure reason codes). The fingerprint authentication unit extracts the last N authentication records (e.g., 50) as a time-series vector at the time of authentication request and calculates statistics (success rate, average authentication time, failure trends, etc.). Furthermore, the fingerprint authentication unit inputs the history vector to a history analysis AI (e.g., LSTM-based time-series analysis model with over 5 million parameters) and obtains as output “recommended authentication speed parameters” (e.g., category labels such as standard, fast, slow, or specific timeout values, retry counts, etc.). Examples of AI input include (1) the last 50 authentication result vectors ([1,0,1,1,0, . . . ]), (2) authentication duration for each attempt ([1.2, 1.0, 1.5, . . . ] seconds), and (3) failure reason code sequences ([0,2,0,1, . . . ]). Examples of AI output include (1) recommended authentication speed “fast”+confidence 0.93, (2) recommended authentication speed “slow”+confidence 0.88, (3) recommended timeout value 2.0 seconds. The fingerprint authentication unit dynamically adjusts the timeout value, retry count, and UI display speed of the authentication algorithm based on the AI output. For example, if the success rate is high, the authentication process is accelerated; if failure trends are strong, the authentication procedure is carefully guided with priority on accuracy. Thus, the authentication experience can be optimized according to each user's usage trends and situation. Unlike conventional uniform authentication speed settings, this configuration combines AI-based history analysis, parameter optimization, and rule-based control to achieve a high-level balance of authentication efficiency, user satisfaction, and security. Application fields include personal authentication for financial terminals, attendance management in educational settings, access control in medical settings, and creator work management systems. Technical effects include (1) dynamic authentication speed control based on history, enabling both user experience and security, (2) prediction of authentication failure and suppression of retries through AI-based history analysis, and (3) improved overall system processing efficiency through authentication process optimization. The configuration and processing of the fingerprint authentication unit realize the advancement of computer technology by integrating AI, history databases, time-series analysis, and authentication algorithm control, not merely automating human work.

The fingerprint authentication unit can detect changes in the user's fingerprint pattern during fingerprint authentication and automatically update the authentication algorithm. For example, the fingerprint authentication unit detects changes in the user's fingerprint pattern during fingerprint authentication and automatically updates the authentication algorithm. The fingerprint authentication unit uses an algorithm for detecting changes in fingerprint patterns to detect changes in the user's fingerprint pattern. For example, if the user's fingerprint pattern changes, the fingerprint authentication unit learns the new pattern and updates the authentication algorithm. If the user's fingerprint is dry, the fingerprint authentication unit can adjust the authentication algorithm considering changes in the fingerprint pattern. If the user's fingerprint is moist, the fingerprint authentication unit can also adjust the authentication algorithm considering changes in the fingerprint pattern. By detecting changes in the user's fingerprint pattern and automatically updating the authentication algorithm, authentication accuracy is improved. Specifically, the fingerprint authentication unit inputs the latest fingerprint image (e.g., 256×256 pixel grayscale image) obtained from the fingerprint sensor to a CNN-based feature extraction model to generate a feature vector (e.g., 128 dimensions). The fingerprint authentication unit calculates the cosine similarity or Euclidean distance between the previously registered fingerprint feature vector and the latest vector, and if it falls below a certain threshold (e.g., less than 0.85), determines “pattern change detected.” Examples of AI input include (1) latest fingerprint image tensor (1×256×256), (2) previously registered vector (128 dimensions), and (3) environmental metadata (humidity, temperature, dry/moist flag, etc.). Examples of AI output include (1) pattern change detection flag (1/0), (2) recommended algorithm update action (retraining, threshold adjustment, etc.), and (3) confidence score (e.g., 0.91). If a pattern change is detected, the fingerprint authentication unit activates an additional learning module and partially retrains (fine-tunes) the CNN model weights using the latest fingerprint image. If environmental changes such as dryness or moisture are detected, preprocessing parameters (e.g., contrast adjustment, noise removal strength) and authentication thresholds are automatically adjusted. Thus, authentication accuracy can be maintained and improved according to the user's biometric state and environmental changes. Unlike conventional static fingerprint authentication, this configuration combines AI-based pattern change detection, dynamic model updating, and environmental adaptation control to greatly reduce authentication accuracy degradation and false authentication risk during long-term use. Application fields include personal authentication terminals used for long periods, access control in medical settings, attendance management in educational settings, and creator work management systems. Technical effects include (1) greatly improved authentication accuracy and reliability through automatic adaptation to fingerprint pattern changes, (2) reduced false authentication and re-registration frequency through AI-based environmental adaptation, and (3) reduced maintenance burden during long-term operation through automatic model retraining. The configuration and processing of the fingerprint authentication unit realize the advancement of computer technology by integrating AI, biometric sensors, pattern change detection, and automatic model updating, not merely automating human work.

The fingerprint authentication unit can estimate the user's emotion and adjust the timing of fingerprint authentication based on the estimated emotion of the user. For example, the fingerprint authentication unit estimates the user's emotion and adjusts the timing of fingerprint authentication based on the estimated emotion. The fingerprint authentication unit estimates the user's emotion using an emotion estimation algorithm. For example, if the user is nervous, the fingerprint authentication unit delays the timing of fingerprint authentication to allow the user to relax. If the user is relaxed, the fingerprint authentication unit can return the timing to normal. Furthermore, if the user is in a hurry, the fingerprint authentication unit can advance the timing to perform authentication quickly. By adjusting the timing of fingerprint authentication based on the user's emotion, authentication accuracy is improved. Emotion estimation is realized using, for example, an emotion engine or generative AI with emotion estimation functions. Generative AI includes text generation AI (e.g., LLM) and multimodal generative AI, but is not limited to these examples. Specifically, the fingerprint authentication unit uses a multimodal AI model (e.g., Transformer architecture integrating audio, facial images, and biometric signals, with over 100 million parameters) for user emotion estimation. The fingerprint authentication unit acquires as input (1) audio data (e.g., speech waveform tensor, 1×16000×seconds), (2) facial images (e.g., face images acquired by the camera unit, 3×224×224 pixels), and (3) biometric signals (e.g., heart rate, skin conductance as time-series vectors), preprocesses these (noise removal, normalization, feature extraction), and inputs them to the AI model. The AI model extracts feature vectors from each input data and outputs emotion labels such as “nervous,” “relaxed,” “in a hurry” (e.g., one-hot vectors, probability distributions [0.6, 0.3, 0.1]) using attention mechanisms and multi-head classifiers. Output examples include (1) emotion label “nervous”+confidence 0.88, (2) emotion label “relaxed”+confidence 0.91, (3) emotion label “in a hurry”+confidence 0.80. The fingerprint authentication unit dynamically controls the timing of the authentication process (e.g., delay in displaying the authentication start button on the UI, timing of authentication request pop-up display) according to the AI output. For example, if a nervous state is estimated, the authentication start is delayed by several seconds and a relaxation-inducing message is displayed; for a relaxed state, immediate authentication is performed; for a hurried state, the authentication request is displayed immediately to prompt quick authentication. Thus, the authentication experience can be optimized according to the user's psychological state, reducing authentication failures due to misoperation or stress. Unlike conventional uniform authentication timing control, this configuration combines AI-based emotion estimation, process control, and user interface linkage to achieve a high-level balance of authentication accuracy, user experience, and system flexibility. Application fields include personal authentication for financial terminals, exam authentication in educational settings, access control in medical settings, and creator work management systems. Technical effects include (1) reduced false authentication, stress, and operational errors through authentication timing control according to emotional state, (2) personalized authentication experience through AI-based multimodal emotion estimation, and (3) greatly improved user satisfaction through increased flexibility of the authentication process. The configuration and processing of the fingerprint authentication unit realize the advancement of computer technology by integrating AI, biometric sensors, multimodal inference, and process control, not merely automating human work.

The fingerprint authentication unit can determine the priority of authentication during fingerprint authentication by considering the user's geographic location information. For example, the fingerprint authentication unit determines the priority of authentication during fingerprint authentication by considering the user's geographic location information. The fingerprint authentication unit uses GPS data to acquire geographic location information. For example, if the user is at home, the fingerprint authentication unit sets the authentication priority low. If the user is in a public place, the fingerprint authentication unit can set the authentication priority high. Furthermore, if the user is in a specific location, the fingerprint authentication unit can adjust the authentication priority according to the location. By considering the user's geographic location information, authentication priority can be optimized. Specifically, the fingerprint authentication unit acquires the current location of the user device as latitude and longitude (e.g., 35.6895, 139.6917) using a GPS reception module or Wi-Fi/Bluetooth location estimation module, and determines location categories such as “home,” “workplace,” “public facility,” “outdoors” in cooperation with a location information database. The fingerprint authentication unit combines location information with the user's past authentication history (e.g., authentication success rate, failure rate, usage frequency by location) to calculate an authentication priority score (e.g., continuous value from 0.2 to 1.0). Examples of AI input include (1) current latitude and longitude vector, (2) location category label (one-hot vector), and (3) location-specific authentication history vector for the past 30 days (e.g., 10 successes at home, 2 failures at public facilities). Examples of AI output include (1) authentication priority score (e.g., home 0.3, public facility 0.9), (2) recommended authentication mode (normal, strict, relaxed), and (3) confidence score (e.g., 0.95). The fingerprint authentication unit dynamically controls the priority of the authentication process (e.g., whether to execute background authentication, immediate display of authentication requests, request for additional authentication elements) based on the AI output. For example, in public facilities or places used by many people, the authentication priority is set high and additional biometric or two-factor authentication is required, while at home or trusted locations, the authentication priority is set low and the authentication process is simplified. Thus, authentication experience and safety can be optimized according to the user's usage environment and security risk. Unlike conventional uniform authentication priority settings, this configuration combines AI-based location information analysis, history linkage, and rule-based control to achieve a high-level balance of authentication efficiency, security, and user experience. Technical effects include (1) simultaneous enhancement of security in high-risk locations and convenience in trusted locations through dynamic authentication priority control based on geographic location information, (2) optimization of the authentication process through AI-based history and location linkage, and (3) flexible response to each user's usage trends and environmental changes. Application fields include location-dependent authentication for financial terminals, access control inside and outside schools in educational settings, zone-based access management in medical settings, and creator work management systems. The configuration and processing of the fingerprint authentication unit realize the advancement of computer technology by integrating AI, location information sensors, history databases, and authentication algorithm control, not merely automating human work.

The fingerprint authentication unit can analyze the user's device usage history during fingerprint authentication and improve the accuracy of authentication. For example, the fingerprint authentication unit analyzes the user's device usage history during fingerprint authentication and improves the accuracy of authentication. The fingerprint authentication unit stores device usage history in a database and refers to it during authentication to optimize authentication accuracy. For example, if the user frequently uses the device, the fingerprint authentication unit increases the accuracy of authentication. If the user has not used the device for a long period, the fingerprint authentication unit can return the accuracy to normal. Furthermore, the fingerprint authentication unit can analyze the user's device usage history and automatically set the optimal authentication accuracy. By analyzing the user's device usage history, authentication accuracy is improved. Specifically, the fingerprint authentication unit manages a device usage history database for each user (e.g., structured tables including usage date and time, usage count, consecutive usage days, last usage date, types of applications used). The fingerprint authentication unit extracts usage history for the last N days (e.g., 30 days) as a time-series vector at the time of authentication request and calculates statistics (average usage count, consecutive usage days, elapsed days since last use, etc.). Furthermore, the fingerprint authentication unit inputs the history vector to a history analysis AI (e.g., LSTM-based time-series analysis model with over 5 million parameters) and obtains as output “recommended authentication accuracy parameters” (e.g., category labels such as strengthened threshold, normal, relaxed, or specific cosine similarity threshold, retry count, etc.). Examples of AI input include (1) usage count vector for the last 30 days ([3,2,0,1, . . . ]), (2) elapsed days since last use (e.g., 5 days), and (3) application type usage vector (e.g., summarization unit used 10 times, browsing unit used 5 times). Examples of AI output include (1) recommended authentication accuracy “high”+confidence 0.94, (2) recommended authentication accuracy “normal”+confidence 0.90, (3) recommended threshold 0.88. The fingerprint authentication unit dynamically adjusts the threshold, retry count, and detail level of the authentication procedure based on the AI output. For example, if the device is frequently used, authentication accuracy is increased to enhance security; if not used for a long period, normal settings are restored to optimize the balance between convenience and safety. Unlike conventional uniform authentication accuracy settings, this configuration combines AI-based history analysis, parameter optimization, and rule-based control to achieve a high-level balance of authentication efficiency, user satisfaction, and security. Technical effects include (1) simultaneous reduction of unauthorized use risk and improvement of convenience through dynamic authentication accuracy control based on usage history, (2) detection of usage trend changes and anomalies through AI-based history analysis, and (3) improved overall system processing efficiency through authentication process optimization. Application fields include usage history-linked authentication for financial terminals, attendance management in educational settings, access control in medical settings, and creator work management systems. The configuration and processing of the fingerprint authentication unit realize the advancement of computer technology by integrating AI, history databases, time-series analysis, and authentication algorithm control, not merely automating human work.

The summarization unit can estimate the user's emotion and adjust the method of summarization expression based on the estimated emotion of the user. For example, the summarization unit estimates the user's emotion and adjusts the method of summarization expression based on the estimated emotion. The summarization unit estimates the user's emotion using an emotion estimation algorithm. For example, if the user is relaxed, the summarization unit provides a detailed summary. If the user is in a hurry, the summarization unit can provide a concise summary. Furthermore, if the user is excited, the summarization unit can provide a visually attractive summary. By adjusting the method of summarization expression based on the user's emotion, more appropriate summaries are generated. Emotion estimation is realized using, for example, an emotion engine or generative AI with emotion estimation functions. Generative AI includes text generation AI (e.g., LLM) and multimodal generative AI, but is not limited to these examples. Specifically, the summarization unit uses a multimodal AI model (e.g., Transformer architecture integrating audio, facial images, and biometric signals, with over 100 million parameters) for user emotion estimation. The summarization unit acquires as input (1) audio data (e.g., speech waveform tensor, 1×16000×seconds), (2) facial images (e.g., face images acquired by the camera unit, 3×224×224 pixels), and (3) biometric signals (e.g., heart rate, skin conductance as time-series vectors), preprocesses these (noise removal, normalization, feature extraction), and inputs them to the AI model. The AI model extracts feature vectors from each input data and outputs emotion labels such as “relaxed,” “in a hurry,” “excited” (e.g., one-hot vectors, probability distributions [0.6, 0.3, 0.1]) using attention mechanisms and multi-head classifiers. Output examples include (1) emotion label “relaxed”+confidence 0.91, (2) emotion label “in a hurry”+confidence 0.85, (3) emotion label “excited”+confidence 0.88. The summarization unit dynamically adjusts prompts and parameters (summary length, level of detail, expression style, presence of visual elements, etc.) for the summary generation AI (e.g., 12-layer Transformer-based large-scale language model with over 100 million parameters) according to the AI output. For example, in a relaxed state, a detailed summary (e.g., 200 characters, with charts) is generated; in a hurried state, a concise summary (e.g., 50 characters, bullet points); in an excited state, a visually attractive summary with colors and icons is generated. Examples of AI input include (1) text strings after handwriting recognition (UTF-8 encoding), (2) emotion label, and (3) summary generation parameters (length, style, etc.). Examples of AI output include (1) detailed summary text (e.g., “Today's minutes: meeting purpose, decisions, issues”), (2) concise summary text (e.g., “Meeting highlights”), and (3) visual summary (summary with icons, color coding, etc.). These outputs are sent to the browsing unit and sharing unit, allowing users to easily search and browse via the dedicated application. Unlike conventional uniform summary generation, this configuration combines AI-based emotion estimation, summary generation parameter control, and multimodal linkage to achieve a high-level balance of user experience, summary accuracy, and diversity of expression. Technical effects include (1) improved user satisfaction and information transmission efficiency through summary expression control according to emotional state, (2) individual optimization through AI-based multimodal inference, and (3) improved accessibility and comprehension through visual summary generation. Application fields include note summarization in educational settings, automatic summarization of business minutes, extraction of key points from research notes, and summarization functions in diary applications. The configuration and processing of the summarization unit realize the advancement of computer technology by integrating AI, emotion estimation, summary generation, and user interface technologies, not merely automating human work.

The summarization unit can adjust the level of detail of the summary based on the importance of the text during summary generation. For example, the summarization unit adjusts the level of detail of the summary based on the importance of the text during summary generation. The summarization unit uses an algorithm for evaluating the importance of the text to adjust the level of detail of the summary. For example, if the text is important, the summarization unit provides a detailed summary. If the text is of low importance, the summarization unit can provide a concise summary. Furthermore, the summarization unit can analyze the importance of the text and automatically set the optimal level of detail for the summary. By adjusting the level of detail of the summary based on the importance of the text, more appropriate summaries are generated. Specifically, the summarization unit uses an importance evaluation AI (e.g., Transformer-based classification model with over 50 million parameters) to calculate importance scores (e.g., continuous values from 0.0 to 1.0) for each sentence or paragraph in the input text. Examples of AI input include (1) text strings after handwriting recognition (UTF-8 encoding, up to 512 tokens), and (2) text metadata (creation date, user ID, tag information, etc.). Examples of AI output include (1) importance score array for each sentence ([0.9, 0.7, 0.2, . . . ]), (2) overall importance label (high, medium, low), and (3) confidence score (e.g., 0.96). The summarization unit dynamically adjusts prompts and parameters (summary length, level of detail, number of extracted sentences, etc.) for the summary generation AI (e.g., 12-layer Transformer-based large-scale language model with over 100 million parameters) according to the importance score. For example, if the importance is high, a detailed summary (e.g., 200 characters, extraction of 3 important sentences) is generated; if the importance is low, a concise summary (e.g., 50 characters, extraction of 1 sentence) is generated. Examples of AI output include (1) detailed summary text (e.g., “Today's minutes: meeting purpose, decisions, issues”), (2) concise summary text (e.g., “Meeting highlights”), and (3) list of important keywords (e.g., “Decisions,” “Issues”). These outputs are sent to the browsing unit and sharing unit, allowing users to easily search and browse via the dedicated application. Unlike conventional uniform summary generation, this configuration combines AI-based importance evaluation, summary generation parameter control, and rule-based processing to achieve a high-level balance of summary accuracy, information transmission efficiency, and user experience. Technical effects include (1) improved information selection and transmission efficiency through control of summary detail according to importance, (2) elimination of overlooked or redundant information through AI-based importance evaluation, and (3) optimized summary generation for each user. Application fields include note summarization in educational settings, automatic summarization of business minutes, extraction of key points from research notes, and summarization functions in diary applications. The configuration and processing of the summarization unit realize the advancement of computer technology by integrating AI, importance evaluation, summary generation, and user interface technologies, not merely automating human work.

The summarization unit can apply different summarization algorithms according to the category of the text during summary generation. For example, the summarization unit applies different summarization algorithms according to the category of the text during summary generation. The summarization unit uses an algorithm for classifying the category of the text to apply different summarization algorithms. For example, for technical documents, the summarization unit applies a specialized summarization algorithm. For novels, the summarization unit can apply a story summarization algorithm. Furthermore, for news articles, the summarization unit can apply a summarization algorithm that emphasizes timeliness. By applying different summarization algorithms according to the category of the text, more appropriate summaries are generated. Specifically, the summarization unit uses a category classification AI (e.g., BERT-based text classification model with over 50 million parameters) to determine category labels such as “technical document,” “novel,” “news article,” “diary” for the input text. Examples of AI input include (1) text strings after handwriting recognition (UTF-8 encoding), and (2) text metadata (creation date, user ID, tag information, etc.). Examples of AI output include (1) category label (e.g., “technical document”), (2) category confidence score (e.g., 0.93), and (3) recommended summarization algorithm ID (1,2,3, etc.). The summarization unit dynamically switches prompts and parameters (summary style, extraction of technical terms, extraction of story elements, emphasis on timeliness, etc.) for the summary generation AI (e.g., 12-layer Transformer-based large-scale language model with over 100 million parameters) according to the category label. For example, for technical documents, specialized terminology and structured summarization are emphasized; for novels, story elements and character extraction are emphasized; for news articles, timeliness and chronological summarization are emphasized. Examples of AI output include (1) technical summary text (e.g., “Main points of the invention”), (2) story summary text (e.g., “The protagonist's adventure”), and (3) news summary text (e.g., “Overview of the incident”). These outputs are sent to the browsing unit and sharing unit, allowing users to easily search and browse via the dedicated application. Unlike conventional uniform summary generation, this configuration combines AI-based category classification, summarization algorithm switching, and rule-based processing to achieve a high-level balance of summary accuracy, information transmission efficiency, and user experience. Technical effects include (1) improved information selection and transmission efficiency through application of summarization algorithms according to category, (2) flexible response to diverse texts through AI-based category classification, and (3) optimized summary generation for each user. Application fields include note summarization in educational settings, automatic summarization of business minutes, extraction of key points from research notes, and summarization functions in diary applications. The configuration and processing of the summarization unit realize the advancement of computer technology by integrating AI, category classification, summary generation, and user interface technologies, not merely automating human work.

The summarization unit can estimate the user's emotion and adjust the length of the summary based on the estimated emotion of the user. For example, the summarization unit estimates the user's emotion and adjusts the length of the summary based on the estimated emotion. The summarization unit estimates the user's emotion using an emotion estimation algorithm. For example, if the user is relaxed, the summarization unit provides a longer summary. If the user is in a hurry, the summarization unit can provide a shorter summary. Furthermore, if the user is excited, the summarization unit can provide a visually attractive summary. By adjusting the length of the summary based on the user's emotion, more appropriate summaries are generated. Emotion estimation is realized using, for example, an emotion engine or generative AI with emotion estimation functions. Generative AI includes text generation AI (e.g., LLM) and multimodal generative AI, but is not limited to these examples. Specifically, the summarization unit uses a multimodal AI model (e.g., Transformer architecture integrating audio, facial images, and biometric signals, with over 100 million parameters) for user emotion estimation. The summarization unit acquires as input (1) audio data (e.g., speech waveform tensor, 1×16000×seconds), (2) facial images (e.g., face images acquired by the camera unit, 3×224×224 pixels), and (3) biometric signals (e.g., heart rate, skin conductance as time-series vectors), preprocesses these (noise removal, normalization, feature extraction), and inputs them to the AI model. The AI model extracts feature vectors from each input data and outputs emotion labels such as “relaxed,” “in a hurry,” “excited” (e.g., one-hot vectors, probability distributions [0.6, 0.3, 0.1]) using attention mechanisms and multi-head classifiers. Output examples include (1) emotion label “relaxed”+confidence 0.91, (2) emotion label “in a hurry”+confidence 0.85, (3) emotion label “excited”+confidence 0.88. The summarization unit dynamically adjusts prompts and parameters (summary length, level of detail, expression style, etc.) for the summary generation AI (e.g., 12-layer Transformer-based large-scale language model with over 100 million parameters) according to the AI output. For example, in a relaxed state, a longer summary (e.g., 200 characters) is generated; in a hurried state, a shorter summary (e.g., 50 characters); in an excited state, a visually attractive summary with colors and icons is generated. Examples of AI input include (1) text strings after handwriting recognition (UTF-8 encoding), (2) emotion label, and (3) summary generation parameters (length, style, etc.). Examples of AI output include (1) long summary text (e.g., “Today's minutes: meeting purpose, decisions, issues”), (2) short summary text (e.g., “Meeting highlights”), and (3) visual summary (summary with icons, color coding, etc.). These outputs are sent to the browsing unit and sharing unit, allowing users to easily search and browse via the dedicated application. Unlike conventional uniform summary length settings, this configuration combines AI-based emotion estimation, summary generation parameter control, and multimodal linkage to achieve a high-level balance of user experience, summary accuracy, and diversity of expression. Technical effects include (1) improved user satisfaction and information transmission efficiency through summary length control according to emotional state, (2) individual optimization through AI-based multimodal inference, and (3) improved accessibility and comprehension through visual summary generation. Application fields include note summarization in educational settings, automatic summarization of business minutes, extraction of key points from research notes, and summarization functions in diary applications. The configuration and processing of the summarization unit realize the advancement of computer technology by integrating AI, emotion estimation, summary generation, and user interface technologies, not merely automating human work.

The summarization unit can determine the priority of summaries based on the creation time of the text during summary generation. For example, the summarization unit determines the priority of summaries based on the creation time of the text during summary generation. The summarization unit uses an algorithm to evaluate the creation time of the text and determine the priority of the summary. For instance, the summarization unit sets a higher priority for recently created texts and a lower priority for older texts. Furthermore, the summarization unit can analyze the creation time of the text and automatically set the optimal priority for the summary. By determining the priority of summaries based on the creation time of the text, more appropriate summaries can be generated. Specifically, the summarization unit acquires metadata of the input text (such as creation date and timestamp) and uses a time-series analysis AI (e.g., an LSTM-based time-series classification model with more than 5 million parameters) to calculate a summary generation priority score (e.g., a continuous value from 0.0 to 1.0). Examples of AI inputs include (1) text creation date (UNIX epoch seconds, etc.), (2) current date and time, and (3) past summary generation history vectors (e.g., summary dates of the last 30 items). Examples of AI outputs include (1) summary priority score (e.g., 0.95), (2) priority label (high, medium, low, etc.), and (3) confidence score (e.g., 0.97). Based on the AI output, the summarization unit dynamically controls the execution order and resource allocation of the summary generation process (e.g., immediate summarization for high-priority texts, batch processing for low-priority texts). For example, recently created texts are summarized immediately, while older texts are processed later, thereby improving user access to the latest information. Unlike conventional uniform summary order settings, this configuration combines AI-based time-series analysis, priority control, and resource optimization to achieve high-level summary generation efficiency, information freshness, and user experience. Technical effects include: (1) priority control of summaries according to creation time enables both immediate summarization of the latest information and efficient management of older information; (2) time-series analysis by AI allows flexible adaptation to information freshness and usage trends; and (3) overall system resource optimization becomes possible. Application fields include note summarization in educational settings, automatic summarization of business minutes, extraction of key points from research notes, and summary functions in diary applications. The configuration and processing of the summarization unit realize the advancement of computer technology by integrating AI, time-series analysis, summary generation, and resource control technologies, rather than merely automating human tasks.

The system according to the embodiment is not limited to the examples described above and can be variously modified, for example, as follows. Specifically, the system allows for diverse variations in AI model architecture, sensor configuration, database design, user interface, communication methods, and more. For example, as AI models, architectures such as CNN, RNN, autoregressive models, and graph neural networks can be adopted in addition to Transformer architectures. Regarding sensor configuration, additional or alternative sensors such as pressure sensors, accelerometers, heart rate sensors, galvanic skin response sensors, GPS, and environmental sensors can be used. For database design, relational databases, NoSQL databases, and blockchain-type ledgers can be selected. For user interfaces, implementations for smartphone apps, web apps, and wearable device UIs are possible. Communication methods can combine wireless communications such as Wi-Fi, Bluetooth, LTE, 5G, NFC, and wired communications. Furthermore, learning methods for AI models such as transfer learning, online learning, self-supervised learning, and reinforcement learning can also be applied. These modifications allow for flexible selection of optimal configurations according to application fields, operational environments, and user needs. Technical effects include: (1) significant improvement in system scalability, flexibility, and adaptability through combinations of diverse AI, sensor, database, and communication technologies; (2) rapid response to new technologies and operational requirements; and (3) easy optimization according to user experience and security requirements. Application fields include education, business, healthcare, creator work management, research note management, and IoT device integration. The configuration and processing of the system realize the advancement of computer technology by integrating AI, sensor, database, communication, and user interface technologies, rather than merely automating human tasks.

The pen-type device system may further comprise a pressure detection unit configured to detect the user's writing pressure. The pressure detection unit detects the writing pressure when the user uses the pen and records the data. For example, the pressure detection unit can distinguish between parts written with strong pressure and parts written with weak pressure and store them as digital data. The pressure detection unit can also analyze changes in the user's writing pressure to understand the characteristics of the user's writing style. Furthermore, the pressure detection unit can use the user's pressure data to reproduce the texture of the written text or drawn images. This enables the generation of more realistic digital data based on the user's writing pressure. Specifically, the pen-type device system incorporates a pressure sensor (e.g., capacitive, resistive, piezoelectric, etc.) and acquires the pressure at the pen tip in real time at a sampling rate of 200 Hz or higher. The pressure detection unit records pressure values (e.g., integer values from 0 to 1023) as a time-series array and saves them as a high-dimensional tensor (e.g., 3×N array, where N is the number of samples) in combination with pen coordinate data (x, y, t). Examples of AI inputs include (1) pressure time-series vectors ([512, 600, 450, . . . ]), (2) pen coordinate sequences ([(x1, y1), (x2, y2), . . . ]), and (3) writing speed vectors ([1.2, 1.0, 1.5, . . . ] mm/s). Examples of AI outputs include (1) pressure feature vectors (for user identification, writing style classification, etc.), (2) pressure change patterns (strong→weak, constant, etc.), and (3) texture reproduction parameters (line thickness, shading, etc.). The pressure detection unit uses pressure data to reproduce line width, shading, and texture of written text or drawn images in real time and faithfully display them on a digital canvas. Furthermore, pressure feature vectors can be used for user authentication, behavioral analysis, and emotion estimation (e.g., strong pressure=tension, weak pressure=relaxation). Unlike conventional simple coordinate recording methods, this configuration combines AI-based pressure analysis, texture reproduction, and user feature extraction to simultaneously realize realistic writing experiences, individual optimization, and enhanced security. Technical effects include: (1) improved user experience through realistic texture reproduction based on pressure data; (2) user identification and emotion estimation enabled by extraction and analysis of pressure features; and (3) multifaceted understanding and application of writing behavior through AI analysis of pressure data. Application fields include handwriting instruction in educational settings, digital art creation, management of writing traces in business documents, behavioral analysis with emotion estimation, and texture reproduction for creator works. The configuration and processing of the pressure detection unit realize the advancement of computer technology by integrating AI, sensor, database, and texture reproduction technologies, rather than merely automating human tasks.

The summarization unit can estimate the user's emotion and adjust the tone of the summary based on the estimated emotion. For example, if the user is sad, the summarization unit provides a summary in a gentle tone. If the user is happy, the summarization unit can provide a summary in a bright tone. Furthermore, if the user is angry, the summarization unit can provide a summary in a calm tone. By adjusting the tone of the summary based on the user's emotion, more appropriate summaries can be generated. Specifically, the summarization unit uses a multimodal AI model (e.g., a Transformer architecture integrating voice, facial images, and biometric signals, with more than 100 million parameters) for emotion estimation. The summarization unit acquires as input (1) voice data (e.g., speech waveform tensor, 1×16000×seconds), (2) facial images (e.g., face images acquired by the camera unit, 3×224×224 pixels), and (3) biometric signals (e.g., time-series vectors of heart rate, galvanic skin response, etc.), preprocesses them (noise removal, normalization, feature extraction), and inputs them to the AI model. The AI model extracts feature vectors from each input data and uses attention mechanisms and multi-head classifiers to output emotion labels such as “sadness,” “joy,” and “anger” (e.g., one-hot vectors, probability distributions [0.7, 0.2, 0.1], etc.). Examples of output include (1) emotion label “sadness”+confidence 0.89, (2) emotion label “joy”+confidence 0.93, and (3) emotion label “anger”+confidence 0.87. The summarization unit dynamically adjusts prompts and parameters (tone specification, expression style, etc.) for the summary generation AI (e.g., a large-scale language model based on a 12-layer Transformer with more than 100 million parameters) according to the AI output. For example, in a sadness state, a gentle tone (e.g., “polite wording,” “soft expressions”), in a joy state, a bright tone (e.g., “positive expressions,” “lively tone”), and in an anger state, a calm tone (e.g., “objective,” “composed expressions”) are used to generate summaries. Examples of AI inputs include (1) text sequence after handwriting recognition (UTF-8 encoding), (2) emotion label, and (3) tone specification parameter. Examples of AI outputs include (1) summary text in a gentle tone (e.g., “Although there was a slightly sad event today, I am thinking positively”), (2) summary text in a bright tone (e.g., “It was a wonderful day!”), and (3) summary text in a calm tone (e.g., “Today's discussion proceeded calmly”). These outputs are sent to the browsing unit or sharing unit, allowing the user to easily search and browse them with the dedicated application. Unlike conventional uniform summary tone settings, this configuration combines AI-based emotion estimation, summary generation parameter control, and multimodal integration to achieve high-level user experience, summary accuracy, and diversity of expression. Technical effects include: (1) improved user satisfaction and information transmission efficiency through tone control of summaries according to emotional state; (2) individual optimization enabled by multimodal inference by AI; and (3) improved accessibility and comprehension through diverse tone generation. Application fields include note summarization in educational settings, automatic summarization of business minutes, extraction of key points from research notes, and summary functions in diary applications. The configuration and processing of the summarization unit realize the advancement of computer technology by integrating AI, emotion estimation, summary generation, and user interface technologies, rather than merely automating human tasks.

The browsing unit can analyze the user's browsing history and recommend related summaries or images. For example, the browsing unit recommends related content based on summaries or images the user has browsed in the past. The browsing unit can also provide personalized recommendations based on the user's interests and preferences. Furthermore, the browsing unit can analyze the user's browsing history and recommend trending or popular content. By providing recommendations based on the user's browsing history, more appropriate content can be offered. Specifically, the browsing unit manages a user-specific browsing history database (e.g., a structured table including browsing date and time, summary ID, image ID, number of views, duration of stay, etc.). The browsing unit extracts browsing history vectors (e.g., the last 50 summary IDs, image IDs, viewing frequency, etc.) and inputs them to a recommendation AI (e.g., a recommendation model based on collaborative filtering or a Transformer-based sequence recommendation model with more than 50 million parameters). Examples of AI inputs include (1) browsing history vector ([summary ID1, summary ID2, . . . ]), (2) tag information vector (“technology,” “landscape,” etc.), and (3) viewing frequency and duration vectors. Examples of AI outputs include (1) recommended summary list (list of summary IDs), (2) recommended image list (list of image IDs), and (3) recommendation score (e.g., 0.85). Based on the AI output, the browsing unit prioritizes the display of highly relevant summaries or images on the user interface and provides personalized recommendations and trend recommendations (such as overall popularity rankings). Furthermore, the browsing unit can analyze changes in the user's interests and preferences over time and dynamically optimize the parameters of the recommendation algorithm. Unlike conventional static list displays, this configuration combines AI-based history analysis, recommendation generation, and personalized control to achieve high-level user experience, information discovery efficiency, and system flexibility. Technical effects include: (1) improved user satisfaction and information discovery efficiency through recommendation control based on browsing history; (2) individual optimization enabled by personalized recommendations by AI; and (3) easier discovery of popular content through trend analysis. Application fields include recommendation of note summaries in educational settings, search and reference of business minutes, management of research note trails, and recommendation of creator works. The configuration and processing of the browsing unit realize the advancement of computer technology by integrating AI, history analysis, recommendation generation, and user interface technologies, rather than merely automating human tasks.

The image browsing unit can estimate the user's emotion and adjust the image display method based on the estimated emotion. For example, if the user is relaxed, the image browsing unit displays images in a large size. If the user is in a hurry, the image browsing unit can display images in a small size. Furthermore, if the user is excited, the image browsing unit can display images with animation. By adjusting the image display method based on the user's emotion, more appropriate display can be achieved. Specifically, the image browsing unit uses a multimodal AI model (e.g., a Transformer architecture integrating voice, facial images, and biometric signals, with more than 100 million parameters) for emotion estimation. The image browsing unit acquires as input (1) voice data (e.g., speech waveform tensor, 1×16000×seconds), (2) facial images (e.g., face images acquired by the camera unit, 3×224×224 pixels), and (3) biometric signals (e.g., time-series vectors of heart rate, galvanic skin response, etc.), preprocesses them (noise removal, normalization, feature extraction), and inputs them to the AI model. The AI model extracts feature vectors from each input data and uses attention mechanisms and multi-head classifiers to output emotion labels such as “relaxed,” “in a hurry,” and “excited” (e.g., one-hot vectors, probability distributions [0.6, 0.3, 0.1], etc.). Examples of output include (1) emotion label “relaxed”+confidence 0.91, (2) emotion label “in a hurry”+confidence 0.85, and (3) emotion label “excited”+confidence 0.88. Based on the AI output, the image browsing unit dynamically adjusts parameters of the image display module (display size, animation presence, display speed, etc.). For example, in a relaxed state, images are displayed in a large size; in a hurry, images are displayed in a small size to improve overview; and in an excited state, animation effects (zoom-in, fade-in, etc.) are added to enhance visual appeal. Examples of AI inputs include (1) image ID, (2) emotion label, and (3) display parameters. Examples of AI outputs include (1) display size (large, medium, small), (2) animation specification (on/off), and (3) display speed (standard, fast, etc.). These outputs are reflected in the user interface of the image browsing unit, providing the user with an optimal viewing experience when browsing images with the dedicated application. Unlike conventional uniform image display, this configuration combines AI-based emotion estimation, display parameter control, and multimodal integration to achieve high-level user experience, accessibility, and diversity of expression. Technical effects include: (1) improved user satisfaction and information transmission efficiency through image display control according to emotional state; (2) individual optimization enabled by multimodal inference by AI; and (3) improved accessibility and comprehension through visual effects such as animation. Application fields include viewing works in educational settings, appreciation of digital art, management of creator works, and viewing illustrations in research notes. The configuration and processing of the image browsing unit realize the advancement of computer technology by integrating AI, emotion estimation, image display, and user interface technologies, rather than merely automating human tasks.

The sharing unit can estimate the user's emotion and adjust the timing of sharing based on the estimated emotion. For example, if the user is relaxed, the sharing unit delays the timing of sharing. If the user is in a hurry, the sharing unit can expedite the timing of sharing. Furthermore, if the user is excited, the sharing unit can adjust the timing to share at the optimal moment. By adjusting the timing of sharing based on the user's emotion, more appropriate sharing can be achieved. Specifically, the sharing unit uses a multimodal AI model (e.g., a Transformer architecture integrating voice, facial images, and biometric signals, with more than 100 million parameters) for emotion estimation. The sharing unit acquires as input (1) voice data (e.g., speech waveform tensor, 1×16000×seconds), (2) facial images (e.g., face images acquired by the camera unit, 3×224×224 pixels), and (3) biometric signals (e.g., time-series vectors of heart rate, galvanic skin response, etc.), preprocesses them (noise removal, normalization, feature extraction), and inputs them to the AI model. The AI model extracts feature vectors from each input data and uses attention mechanisms and multi-head classifiers to output emotion labels such as “relaxed,” “in a hurry,” and “excited” (e.g., one-hot vectors, probability distributions [0.6, 0.3, 0.1], etc.). Examples of output include (1) emotion label “relaxed”+confidence 0.91, (2) emotion label “in a hurry”+confidence 0.85, and (3) emotion label “excited”+confidence 0.88. Based on the AI output, the sharing unit dynamically controls the timing of the sharing process (e.g., immediate sharing, delayed sharing, sharing after user confirmation). For example, in a relaxed state, the sharing timing is delayed to prompt user confirmation; in a hurry, sharing is performed immediately; and in an excited state, sharing is executed at the optimal timing (e.g., when the user's concentration is high). Examples of AI inputs include (1) data ID to be shared, (2) emotion label, and (3) timing specification parameter. Examples of AI outputs include (1) sharing timing (immediate, delayed, after confirmation, etc.), (2) sharing priority score (e.g., 0.92), and (3) confidence score. These outputs are reflected in the communication module of the sharing unit, ensuring that data is delivered at the optimal timing when the user performs sharing operations with the dedicated application. Unlike conventional uniform sharing timing settings, this configuration combines AI-based emotion estimation, timing control, and multimodal integration to achieve high-level user experience, sharing efficiency, and security. Technical effects include: (1) improved user satisfaction and information transmission efficiency through sharing timing control according to emotional state; (2) individual optimization enabled by multimodal inference by AI; and (3) enhanced security and privacy management through increased flexibility of the sharing process. Application fields include sharing works in educational settings, collaborative editing of business documents, distribution of creator works, and collaborative management of research notes. The configuration and processing of the sharing unit realize the advancement of computer technology by integrating AI, emotion estimation, sharing control, and communication technologies, rather than merely automating human tasks.

The external microphone can transcribe the user's voice in real time. For example, the external microphone transcribes the user's spoken content in real time and stores it as digital data. The external microphone can also send the transcribed data to the summarization unit to generate a summary. Furthermore, the external microphone can send the transcribed data to the browsing unit, allowing the user to browse it through the application. By transcribing the user's voice in real time, voice information management becomes easier. Specifically, the external microphone acquires 16 kHz, 16-bit PCM format audio waveform data in real time and stores it in WAV or FLAC format in the device's internal storage via a recording control module. The external microphone receives control signals such as start, stop, and pause from the user interface, performs buffering during recording, and prevents data loss or noise contamination. Furthermore, the external microphone sequentially sends the audio data during recording in frame units (e.g., every second) to a speech recognition AI (e.g., an RNN or Transformer-based speech recognition model with more than 10 million parameters) to generate text data (e.g., “meeting minutes”) in real time. Examples of AI inputs include (1) audio waveform tensor (1×16000×seconds) and (2) recording metadata (recording date and time, user ID, etc.). Examples of AI outputs include (1) transcribed voice content (e.g., “Discussed new ideas”) and (2) confidence score (e.g., 0.92). These outputs are sent to the summarization unit and browsing unit for use in summary generation and searching/browsing of voice memos. The external microphone automatically performs preprocessing such as noise reduction and volume normalization on the recording data to improve speech recognition accuracy. Furthermore, users can play back and edit (trim, split, tag, etc.) recorded voice memos with the dedicated application. Unlike conventional manual transcription of recorded data, this configuration combines AI-based real-time speech recognition, summary integration, and database management to achieve high-level management efficiency, searchability, and user experience for voice information. Technical effects include: (1) easy transcription, summarization, and searching of voice memos through collaboration with high-accuracy speech recognition AI; (2) improved recording quality and recognition accuracy through automatic preprocessing such as noise reduction and volume normalization; and (3) enhanced user experience through digital management and editing functions for recording data. Application fields include audio recording of meeting minutes, voice input for diary applications, management of voice memos in research notes, and recording presentations in educational settings. The configuration and processing of the external microphone realize the advancement of computer technology by combining AI, speech recognition, database, and user interface technologies, rather than merely automating human tasks.

The camera unit can estimate the user's emotion and adjust the shooting mode based on the estimated emotion. For example, if the user is relaxed, the camera unit shoots in standard mode. If the user is in a hurry, the camera unit can shoot in quick mode. Furthermore, if the user is excited, the camera unit can shoot in continuous shooting mode. By adjusting the shooting mode based on the user's emotion, more appropriate shooting can be achieved. Specifically, the camera unit uses a multimodal AI model (e.g., a Transformer architecture integrating voice, facial images, and biometric signals, with more than 100 million parameters) for emotion estimation. The camera unit acquires as input (1) voice data (e.g., speech waveform tensor, 1×16000×seconds), (2) facial images (e.g., face images acquired by the camera unit, 3×224×224 pixels), and (3) biometric signals (e.g., time-series vectors of heart rate, galvanic skin response, etc.), preprocesses them (noise removal, normalization, feature extraction), and inputs them to the AI model. The AI model extracts feature vectors from each input data and uses attention mechanisms and multi-head classifiers to output emotion labels such as “relaxed,” “in a hurry,” and “excited” (e.g., one-hot vectors, probability distributions [0.6, 0.3, 0.1], etc.). Examples of output include (1) emotion label “relaxed”+confidence 0.91, (2) emotion label “in a hurry”+confidence 0.85, and (3) emotion label “excited”+confidence 0.88. Based on the AI output, the camera unit dynamically switches parameters of the shooting mode control module (standard shooting, quick shooting, continuous shooting, etc.). For example, in a relaxed state, standard mode (high quality, normal speed) is selected; in a hurry, quick mode (low latency, high-speed shooting) is selected; and in an excited state, continuous shooting mode (multiple shots in succession) is selected. Examples of AI inputs include (1) shooting request, (2) emotion label, and (3) shooting mode specification parameter. Examples of AI outputs include (1) shooting mode (standard, quick, continuous), (2) number of shots, and (3) confidence score. These outputs are reflected in the camera unit's shooting control, providing the user with an optimal shooting experience when acquiring images with the dedicated application. Unlike conventional uniform shooting mode settings, this configuration combines AI-based emotion estimation, shooting mode control, and multimodal integration to achieve high-level user experience, shooting efficiency, and diversity of expression. Technical effects include: (1) improved user satisfaction and shooting efficiency through shooting mode control according to emotional state; (2) individual optimization enabled by multimodal inference by AI; and (3) improved accessibility and expressiveness through diverse shooting modes. Application fields include shooting works in educational settings, recording digital art, management of creator works, and shooting illustrations in research notes. The configuration and processing of the camera unit realize the advancement of computer technology by integrating AI, emotion estimation, shooting control, and user interface technologies, rather than merely automating human tasks.

The device may further comprise an activity measurement unit configured to measure the user's activity level. The activity measurement unit measures the user's steps and amount of exercise and records the data. For example, the activity measurement unit measures the number of steps the user walks in a day and stores it as digital data. The activity measurement unit can also analyze the user's amount of exercise and evaluate health status. Furthermore, the activity measurement unit can provide health management advice using the user's activity data. This enables health management based on the user's activity level. Specifically, the device incorporates accelerometers, gyroscopes, heart rate sensors, etc., and acquires the user's physical motion data (e.g., 3-axis acceleration values, heart rate, number of steps) in real time. The activity measurement unit records acceleration data as a time-series tensor (e.g., 3×N array, where N is the number of samples) and calculates the number of steps, amount of exercise, calories burned, etc., using a step count algorithm and exercise intensity estimation AI (e.g., an LSTM-based time-series analysis model with more than 5 million parameters). Examples of AI inputs include (1) acceleration time-series vector ([0.12, 0.15, . . . ]), (2) heart rate time-series ([72, 75, . . . ]), and (3) step count (e.g., 8000 steps/day). Examples of AI outputs include (1) activity score (e.g., 1.2 METs), (2) health status evaluation (“good,” “caution,” etc.), and (3) health management advice (“Please walk a little more,” etc.). The activity measurement unit records activity data in a database, allowing the user to display and analyze daily activity history and health status in graphs with the dedicated application. Furthermore, AI-based anomaly detection (e.g., sudden decrease in activity, abnormal heart rate) and personalized health advice generation are also possible. Unlike conventional simple step counting, this configuration combines AI-based multivariate analysis, health evaluation, and advice generation to achieve high-level health management efficiency, preventive medicine, and user experience. Technical effects include: (1) easy health management for users through health status evaluation and advice provision based on activity data; (2) early response enabled by AI-based anomaly detection; and (3) realization of personalized health management through multifaceted analysis of activity data. Application fields include daily health management, rehabilitation support, sports training, health guidance in educational settings, and corporate health management. The configuration and processing of the activity measurement unit realize the advancement of computer technology by integrating AI, sensor, health evaluation, and advice generation technologies, rather than merely automating human tasks.

The fingerprint authentication unit can estimate the user's emotion and adjust the fingerprint authentication interface based on the estimated emotion. For example, if the user is relaxed, the fingerprint authentication unit provides a simple interface. If the user is in a hurry, the fingerprint authentication unit can provide an intuitive interface. Furthermore, if the user is excited, the fingerprint authentication unit can provide a visually attractive interface. By adjusting the fingerprint authentication interface based on the user's emotion, more appropriate authentication can be achieved. Specifically, the fingerprint authentication unit uses a multimodal AI model (e.g., a Transformer architecture integrating voice, facial images, and biometric signals, with more than 100 million parameters) for emotion estimation. The fingerprint authentication unit acquires as input (1) voice data (e.g., speech waveform tensor, 1×16000×seconds), (2) facial images (e.g., face images acquired by the camera unit, 3×224×224 pixels), and (3) biometric signals (e.g., time-series vectors of heart rate, galvanic skin response, etc.), preprocesses them (noise removal, normalization, feature extraction), and inputs them to the AI model. The AI model extracts feature vectors from each input data and uses attention mechanisms and multi-head classifiers to output emotion labels such as “relaxed,” “in a hurry,” and “excited” (e.g., one-hot vectors, probability distributions [0.6, 0.3, 0.1], etc.). Examples of output include (1) emotion label “relaxed”+confidence 0.91, (2) emotion label “in a hurry”+confidence 0.85, and (3) emotion label “excited”+confidence 0.88. Based on the AI output, the fingerprint authentication unit dynamically adjusts parameters of the interface control module (UI layout, color scheme, animation presence, operation procedure, etc.). For example, in a relaxed state, a simple UI (minimal buttons, light color scheme) is provided; in a hurry, an intuitive UI (large buttons, shortcut display) is provided; and in an excited state, a visually attractive UI (animation, colorful color scheme) is provided. Examples of AI inputs include (1) authentication request, (2) emotion label, and (3) UI parameters. Examples of AI outputs include (1) UI layout specification (simple, intuitive, visual), (2) color specification, and (3) animation specification. These outputs are reflected in the user interface of the fingerprint authentication unit, providing the user with an optimal experience during authentication operations. Unlike conventional uniform UI settings, this configuration combines AI-based emotion estimation, UI control, and multimodal integration to achieve high-level user experience, accessibility, and authentication efficiency. Technical effects include: (1) improved user satisfaction and authentication efficiency through UI control according to emotional state; (2) individual optimization enabled by multimodal inference by AI; and (3) improved accessibility and comprehension through diverse UI generation. Application fields include personal authentication for financial terminals, exam authentication in educational settings, access control in medical settings, and creator work management systems. The configuration and processing of the fingerprint authentication unit realize the advancement of computer technology by integrating AI, emotion estimation, UI control, and user interface technologies, rather than merely automating human tasks.

The fingerprint authentication unit can encrypt and store the user's fingerprint data. For example, the fingerprint authentication unit encrypts the user's fingerprint data using an encryption algorithm and stores it in the device. The fingerprint authentication unit can also decrypt the encrypted fingerprint data and perform matching during authentication. Furthermore, the fingerprint authentication unit can periodically update the encrypted fingerprint data to enhance security. By encrypting and storing the user's fingerprint data, security is improved. Specifically, the fingerprint authentication unit encrypts fingerprint image data (e.g., 256×256 pixel grayscale images) and feature vectors (e.g., 128 dimensions) obtained from the fingerprint sensor using an encryption module (e.g., AES-256, RSA, elliptic curve cryptography, etc.) and stores them in a secure storage area within the device. Upon authentication request, the fingerprint authentication unit decrypts the encrypted data and calculates the cosine similarity or Euclidean distance between the input fingerprint data and feature vectors for matching. Furthermore, the fingerprint authentication unit is equipped with a key management module to periodically update encryption keys and protect keys using a hardware security module (HSM). Examples of AI inputs include (1) encrypted fingerprint data, (2) decryption request, and (3) authentication request. Examples of AI outputs include (1) decrypted fingerprint data, (2) matching result (1/0), and (3) security audit log. The fingerprint authentication unit also performs periodic updates of encrypted data (e.g., every month) and records access audit logs, and automatically executes warning and lock processing when unauthorized access or tampering is detected. Unlike conventional plaintext storage methods, this configuration combines AI-based encryption, decryption, access auditing, and key management to achieve high-level security, privacy protection, and operational efficiency for fingerprint data. Technical effects include: (1) significant reduction of data leakage risk through encrypted storage; (2) enhanced security through AI-based access auditing and anomaly detection; and (3) improved long-term operational safety through periodic encryption key updates. Application fields include personal authentication for financial terminals, attendance management in educational settings, access control in medical settings, and creator work management systems. The configuration and processing of the fingerprint authentication unit realize the advancement of computer technology by integrating AI, encryption, key management, and security auditing technologies, rather than merely automating human tasks.

The following is a brief description of the processing flow of Example of the Embodiment. Specifically, the system operates in cooperation with multiple processing modules such as biometric authentication, handwriting input, voice input, image input, AI summarization, database management, browsing, sharing, and security control. Each processing step includes acquisition of sensor data, feature extraction and inference by AI, recording to the database, output to the user interface, and security control. For example, the fingerprint authentication unit acquires biometric images from the fingerprint sensor, vectorizes them using a CNN-based feature extraction model, and stores them in the database linked to the user ID. The summarization unit inputs text after handwriting recognition or text after voice recognition to a large-scale language model to generate summary text and tag information. The browsing unit stores summary text and tag information in the database and performs list display, search, and recommendation based on user-specific access rights and history. The image browsing unit analyzes and tags image data using image recognition AI and provides thumbnail generation and enlarged display. The sharing unit distributes summary text and image data to other users via secure communication channels and manages access rights and history. The external microphone acquires audio waveform data in real time, converts it to text using speech recognition AI, and sends it to the summarization unit and browsing unit. The camera unit acquires image data, analyzes and tags content using image recognition AI, and stores it in the database. All generated data is assigned a timestamp and user ID and recorded in a blockchain-type ledger or secure database for tamper prevention and copyright proof. This series of processes functions as an advanced information processing infrastructure that combines AI, sensor, database, and security technologies, simultaneously realizing copyright protection, data management, and improved user experience. Technical effects include: (1) improved data search and management efficiency through automatic summarization, classification, and tagging by AI; (2) prevention of unauthorized use and impersonation through biometric authentication and secure communication; (3) integrated management of multimodal data (text, images, audio, etc.); and (4) easier management of user-specific access rights and history. Application fields include management of student works in educational settings, management of business document trails, copyright proof for creators, tamper prevention for research notes, and distribution management of digital art. The configuration and processing of the system realize the advancement of computer technology by integrating AI, sensor, database, and security technologies, rather than merely automating human tasks.

Step 1: The fingerprint authentication unit individually identifies the user. The fingerprint authentication unit reads the user's fingerprint using a fingerprint sensor and performs individual identification. The fingerprint data is stored in the device and used for individual identification by matching during authentication. Step 2: The summarization unit automatically summarizes text written by the user with a pen using a generative AI. The summarization unit uses a text generation AI (for example, LLM) to concisely summarize the text and can also extract and summarize important parts. Step 3: The browsing unit allows the summarized text to be browsed with a dedicated application. The summarized text is sent to the dedicated application, allowing the user to browse it through the application. Step 4: The image browsing unit allows drawn images to be browsed with a dedicated application. The drawn images are stored as digital data and sent to the dedicated application, allowing the user to browse them through the application. Step 5: The sharing unit shares text or images written or drawn by other users. Text or images written or drawn by other users are shared through the dedicated application, allowing the user to browse them. Step 6: The external microphone is used for recording voice memos by the user. The built-in microphone of the device is used to record audio and store it as digital data. Step 7: The camera unit captures images of drawings or text written by the user and stores them as digital data. The built-in camera of the device is used to capture images and store them as digital data. Specifically, the system operates in cooperation with AI models, sensors, databases, and user interfaces at each step. For example, the fingerprint authentication unit vectorizes fingerprint images (256×256 pixels) using a CNN and stores them in the database linked to the user ID. The summarization unit inputs text after handwriting recognition or text after voice recognition to a large-scale language model (such as a 12-layer Transformer) to generate summary text and tag information. The browsing unit stores summary text and tag information in the database and performs list display, search, and recommendation based on user-specific access rights and history. The image browsing unit analyzes and tags image data using image recognition AI and provides thumbnail generation and enlarged display. The sharing unit distributes summary text and image data to other users via secure communication channels and manages access rights and history. The external microphone acquires audio waveform data in real time, converts it to text using speech recognition AI, and sends it to the summarization unit and browsing unit. The camera unit acquires image data, analyzes and tags content using image recognition AI, and stores it in the database. All generated data is assigned a timestamp and user ID and recorded in a blockchain-type ledger or secure database for tamper prevention and copyright proof. This series of processes functions as an advanced information processing infrastructure that combines AI, sensor, database, and security technologies, simultaneously realizing copyright protection, data management, and improved user experience. Technical effects include: (1) improved data search and management efficiency through automatic summarization, classification, and tagging by AI; (2) prevention of unauthorized use and impersonation through biometric authentication and secure communication; (3) integrated management of multimodal data (text, images, audio, etc.); and (4) easier management of user-specific access rights and history. Application fields include management of student works in educational settings, management of business document trails, copyright proof for creators, tamper prevention for research notes, and distribution management of digital art. The configuration and processing of the system realize the advancement of computer technology by integrating AI, sensor, database, and security technologies, rather than merely automating human tasks.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the aforementioned elements, including the fingerprint authentication unit, summarization unit, browsing unit, image browsing unit, sharing unit, external microphone, and camera unit, is implemented by at least one of, for example, the smart device 14 and the data processing apparatus 12. For example, the fingerprint authentication unit reads the user's fingerprint using a fingerprint sensor of the smart device 14 and performs individual identification. The summarization unit automatically summarizes text using generative AI by a specific processing unit 290 of the data processing apparatus 12. The browsing unit and image browsing unit allow the summarized text and drawn images to be browsed with the iPentity application by a control unit 46A of the smart device 14. The sharing unit shares text or images written or drawn by other users through the control unit 46A of the smart device 14. The external microphone records audio using a microphone built into the smart device 14, and the camera unit captures images using a camera built into the smart device 14 and stores them as digital data. The correspondence between each unit and the device or control unit is not limited to the examples described above and various modifications are possible.

### Second Embodiment

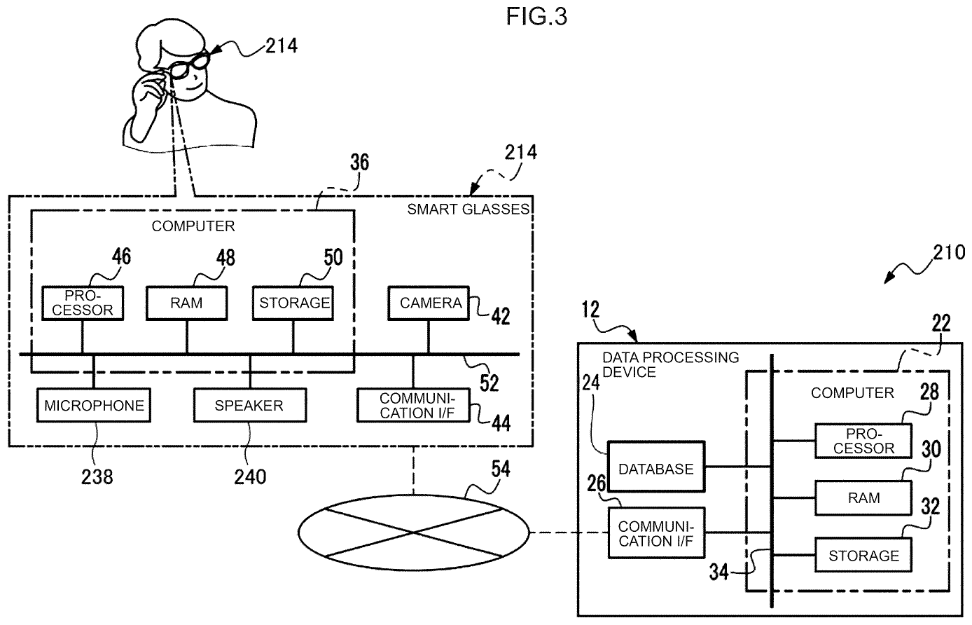

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

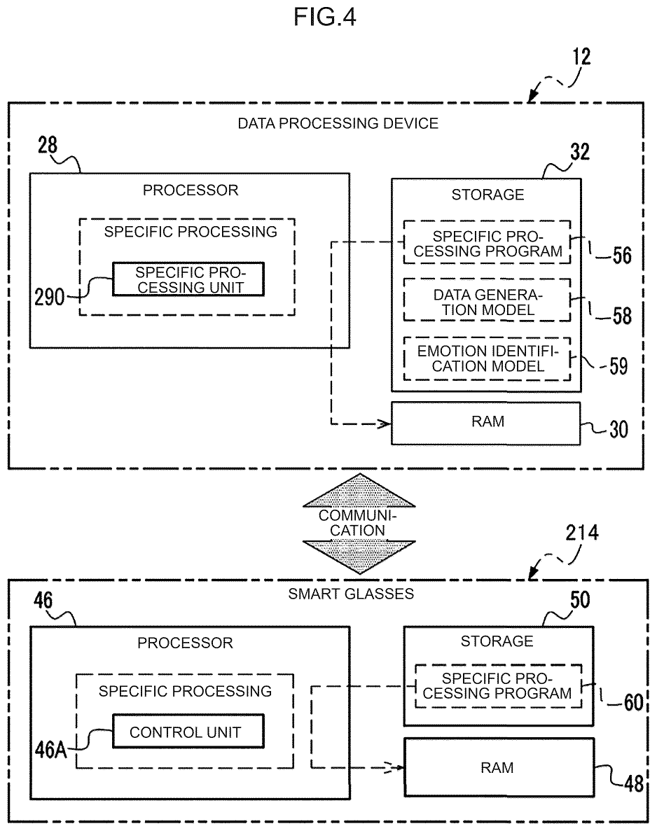

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the aforementioned elements, including the fingerprint authentication unit, summarization unit, browsing unit, image browsing unit, sharing unit, external microphone, and camera unit, is implemented by at least one of, for example, the smart glasses 214 and the data processing apparatus 12. For example, the fingerprint authentication unit reads the user's fingerprint using a fingerprint sensor of the smart glasses 214 and performs individual identification. The summarization unit automatically summarizes text using generative AI by a specific processing unit 290 of the data processing apparatus 12. The browsing unit and image browsing unit allow the summarized text and drawn images to be browsed with the iPentity application by a control unit 46A of the smart glasses 214. The sharing unit shares text or images written or drawn by other users through the control unit 46A of the smart glasses 214. The external microphone records audio using a microphone built into the smart glasses 214, and the camera unit captures images using a camera built into the smart glasses 214 and stores them as digital data. The correspondence between each unit and the device or control unit is not limited to the examples described above and various modifications are possible.

### Third Embodiment

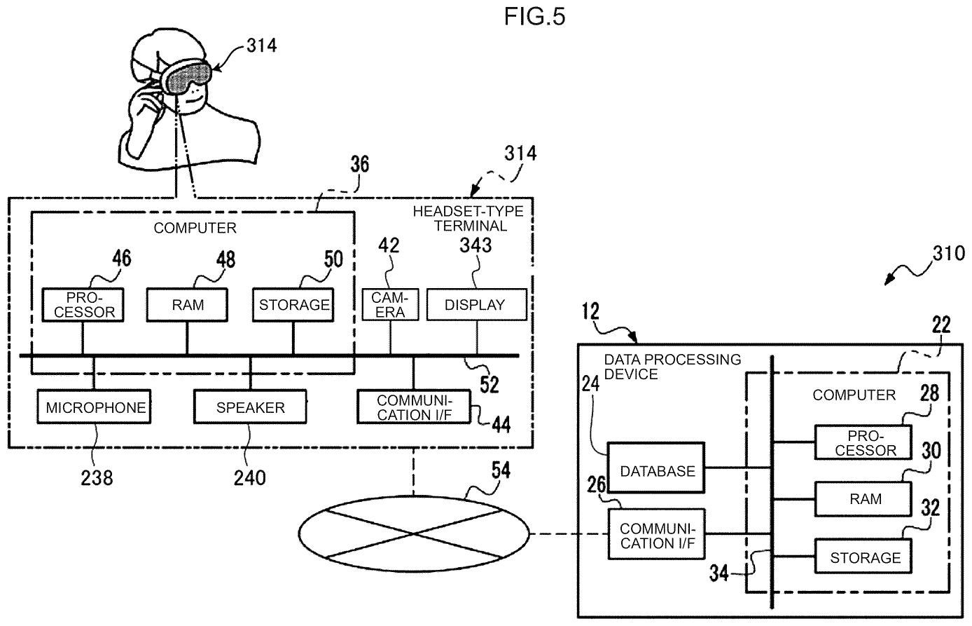

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

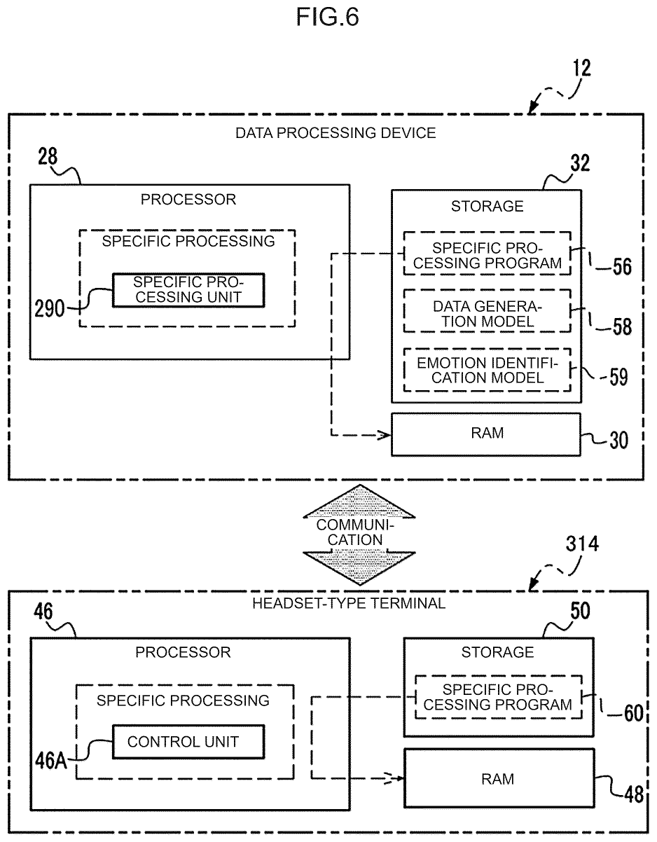

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the aforementioned elements, including the fingerprint authentication unit, summarization unit, browsing unit, image browsing unit, sharing unit, external microphone, and camera unit, is implemented by at least one of, for example, the headset-type terminal 314 and the data processing apparatus 12. For example, the fingerprint authentication unit reads the user's fingerprint using a fingerprint sensor of the headset-type terminal 314 and performs individual identification. The summarization unit automatically summarizes text using generative AI by a specific processing unit 290 of the data processing apparatus 12. The browsing unit and image browsing unit allow the summarized text and drawn images to be browsed with the iPentity application by a control unit 46A of the headset-type terminal 314. The sharing unit shares text or images written or drawn by other users through the control unit 46A of the headset-type terminal 314. The external microphone records audio using a microphone built into the headset-type terminal 314, and the camera unit captures images using a camera built into the headset-type terminal 314 and stores them as digital data. The correspondence between each unit and the device or control unit is not limited to the examples described above and various modifications are possible.

### Fourth Embodiment

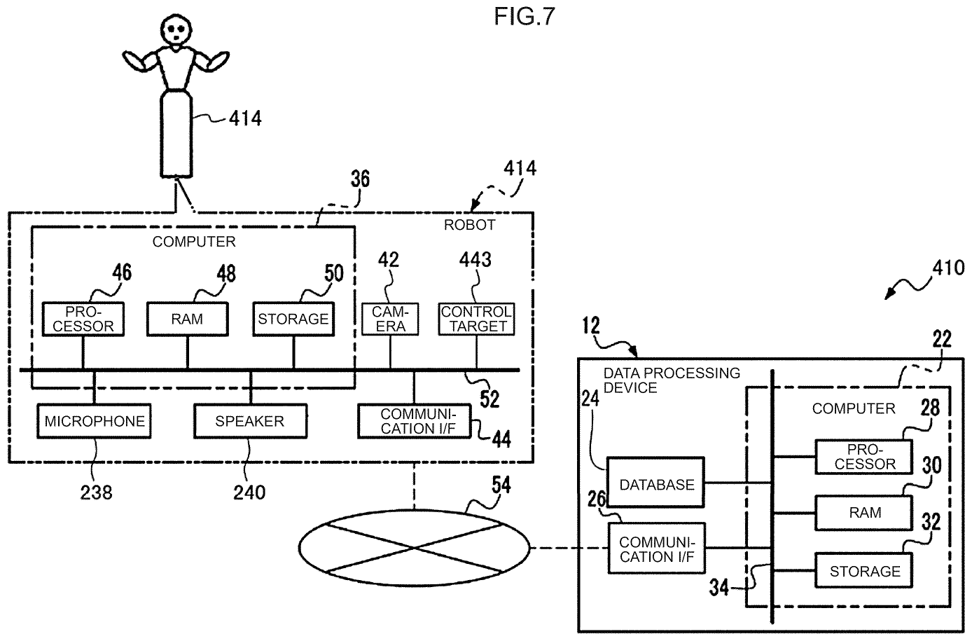

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

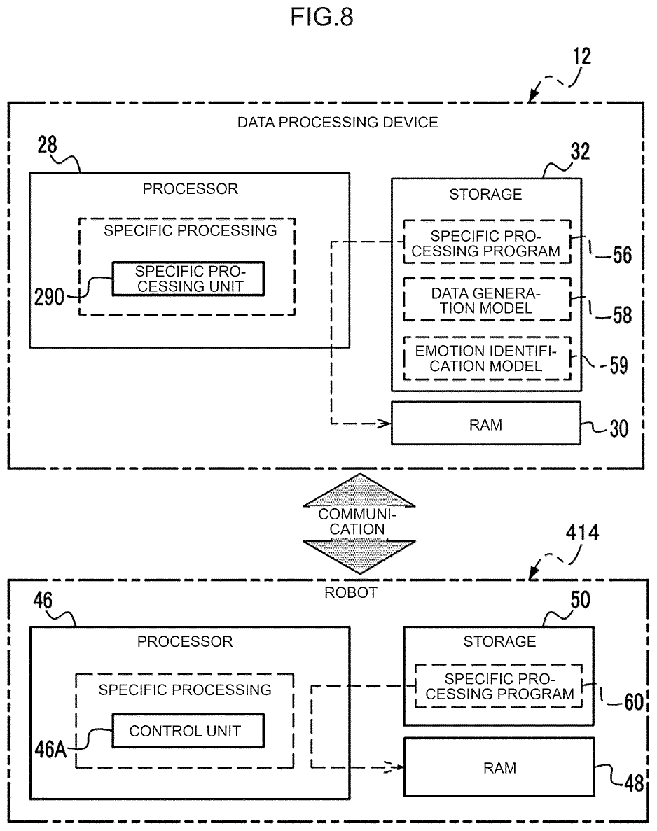

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the aforementioned elements, including the fingerprint authentication unit, summarization unit, browsing unit, image browsing unit, sharing unit, external microphone, and camera unit, is implemented by at least one of, for example, the robot 414 and the data processing apparatus 12. For example, the fingerprint authentication unit reads the user's fingerprint using a fingerprint sensor of the robot 414 and performs individual identification. The summarization unit automatically summarizes text using generative AI by a specific processing unit 290 of the data processing apparatus 12. The browsing unit and image browsing unit allow the summarized text and drawn images to be browsed with the iPentity application by a control unit 46A of the robot 414. The sharing unit shares text or images written or drawn by other users through the control unit 46A of the robot 414. The external microphone records audio using a microphone built into the robot 414, and the camera unit captures images using a camera built into the robot 414 and stores them as digital data. The correspondence between each unit and the device or control unit is not limited to the examples described above and various modifications are possible.

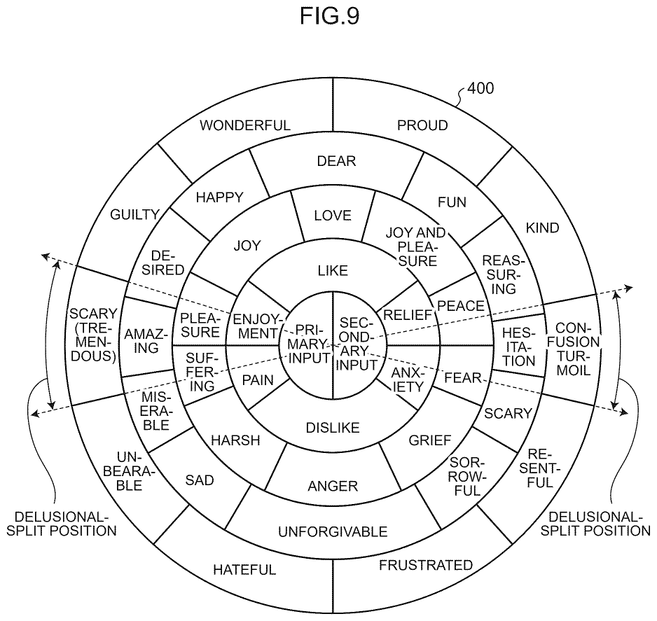

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

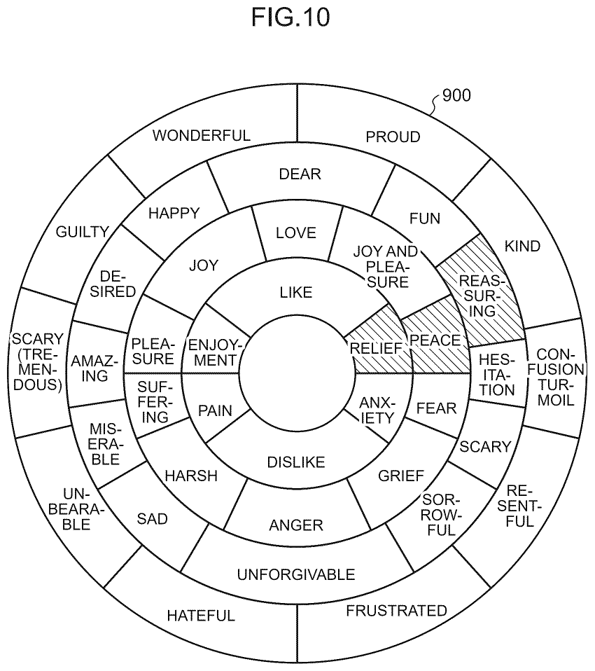

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a fingerprint authentication unit configured to individually identify a user; a summarization unit configured to summarize text written by the user with a pen; a browsing unit configured to allow the summarized text by the summarization unit to be browsed with a dedicated application; an image browsing unit configured to allow drawn images to be browsed with a dedicated application; a sharing unit configured to share text or images written or drawn by other users; an external microphone configured to record audio; and a camera unit configured to record images.
(Supplementary Note 2) The system according to Supplementary Note 1, wherein the summarization unit is configured to automatically summarize text written by the user with a pen.
(Supplementary Note 3) The system according to Supplementary Note 1, wherein the browsing unit is configured to allow the summarized text to be browsed with the iPentity application.
(Supplementary Note 4) The system according to Supplementary Note 1, wherein the image browsing unit is configured to allow drawn images to be browsed with the iPentity application.
(Supplementary Note 5) The system according to Supplementary Note 1, wherein the sharing unit is configured to share text or images written or drawn by other users.
(Supplementary Note 6) The system according to Supplementary Note 1, wherein the external microphone is used for recording voice memos by the user.
(Supplementary Note 7) The system according to Supplementary Note 1, wherein the camera unit is configured to capture images of drawings or text written by the user and store them as digital data.
(Supplementary Note 8) The system according to Supplementary Note 1, wherein a method is provided for protecting copyright by assigning a timestamp to digital data generated by the device and associating it with the user's fingerprint information.
(Supplementary Note 9) The system according to Supplementary Note 1, wherein the fingerprint authentication unit is configured to estimate the user's emotion and adjust the accuracy of fingerprint authentication based on the estimated emotion of the user.
(Supplementary Note 10) The system according to Supplementary Note 1, wherein the fingerprint authentication unit is configured to refer to the user's past authentication history during fingerprint authentication and adjust the authentication speed.
(Supplementary Note 11) The system according to Supplementary Note 1, wherein the fingerprint authentication unit is configured to detect changes in the user's fingerprint pattern during fingerprint authentication and automatically update the authentication algorithm.
(Supplementary Note 12) The system according to Supplementary Note 1, wherein the fingerprint authentication unit is configured to estimate the user's emotion and adjust the timing of fingerprint authentication based on the estimated emotion of the user.
(Supplementary Note 13) The system according to Supplementary Note 1, wherein the fingerprint authentication unit is configured to determine the priority of authentication during fingerprint authentication by considering the user's geographic location information.
(Supplementary Note 14) The system according to Supplementary Note 1, wherein the fingerprint authentication unit is configured to analyze the user's device usage history during fingerprint authentication and improve the accuracy of authentication.
(Supplementary Note 15) The system according to Supplementary Note 1, wherein the summarization unit is configured to estimate the user's emotion and adjust the method of summarization expression based on the estimated emotion of the user.
(Supplementary Note 16) The system according to Supplementary Note 1, wherein the summarization unit is configured to adjust the level of detail of the summary based on the importance of the text during summary generation.
(Supplementary Note 17) The system according to Supplementary Note 1, wherein the summarization unit is configured to apply different summarization algorithms according to the category of the text during summary generation.
(Supplementary Note 18) The system according to Supplementary Note 1, wherein the summarization unit is configured to estimate the user's emotion and adjust the length of the summary based on the estimated emotion of the user.
(Supplementary Note 19) The system according to Supplementary Note 1, wherein the summarization unit is configured to determine the priority of the summary based on the creation time of the text during summary generation.

What is claimed is:

1. A system comprising:
circuitry configured to:
authenticate a user by extracting a feature vector from fingerprint data acquired from a fingerprint sensor and comparing the feature vector against stored reference data;
generate summary data by inputting text data, derived from input acquired from the user, into a data generation model;
cause the summary data to be displayed via an application interface;
cause image data, derived from input acquired from the user, to be displayed via the application interface;
transmit, to a client terminal associated with another user via a communication channel, at least one of the text data or the image data;
convert audio data acquired from a microphone into text data using a speech recognition model; and
perform content analysis on image data acquired from a camera using an image recognition model.

2. The system according to claim 1, wherein the data generation model comprises a Transformer-based large-scale language model.

3. The system according to claim 1, wherein the feature vector is extracted using a convolutional neural network, and the comparing comprises computing a cosine similarity between the feature vector and the stored reference data.

4. The system according to claim 1, wherein the circuitry is further configured to estimate an emotion of the user by inputting at least one of audio data, facial image data, or biometric signal data into an emotion identification model, and adjust a threshold of the authenticating based on the estimated emotion.

5. The system according to claim 4, wherein the emotion identification model comprises a multimodal Transformer architecture configured to receive the audio data, the facial image data, and the biometric signal data, and output an emotion label and a confidence score using an attention mechanism and a multi-head classifier.

6. The system according to claim 1, wherein the circuitry is further configured to refer to a past authentication history of the user and adjust an authentication speed based on a result of inputting the past authentication history into a time-series analysis model.

7. The system according to claim 1, wherein the circuitry is further configured to detect a change in a fingerprint pattern of the user by comparing a current feature vector against a previously registered feature vector, and update an authentication algorithm by fine-tuning model weights based on the current feature vector when the change is detected.

8. The system according to claim 1, wherein the circuitry is further configured to determine an authentication priority based on geographic location information of the user acquired from a location estimation module.

9. The system according to claim 1, wherein the circuitry is further configured to analyze a device usage history of the user and adjust an authentication accuracy parameter based on a result of inputting the device usage history into a history analysis model.

10. The system according to claim 1, wherein the circuitry is further configured to estimate an emotion of the user and adjust a method of expression of the summary data based on the estimated emotion.

11. The system according to claim 1, wherein the circuitry is further configured to calculate an importance score for each portion of the text data using an importance evaluation model, and adjust a level of detail of the summary data based on the importance score.

12. The system according to claim 1, wherein the circuitry is further configured to classify the text data into a category using a category classification model, and select a summarization algorithm from a plurality of summarization algorithms based on the category.

13. The system according to claim 1, wherein the circuitry is further configured to estimate an emotion of the user and adjust a length of the summary data based on the estimated emotion.

14. The system according to claim 1, wherein the circuitry is further configured to assign a timestamp to at least one of the text data or the image data and associate the timestamp with the feature vector of the user to generate a copyright record.

15. The system according to claim 14, wherein the copyright record is stored in a secure database, and the associating comprises computing a hash value using a hash function.

16. The system according to claim 1, wherein the circuitry is further configured to encrypt the fingerprint data using an encryption algorithm and store the encrypted fingerprint data in a secure storage area, and decrypt the encrypted fingerprint data upon an authentication request.

17. The system according to claim 1, wherein the circuitry is further configured to acquire pressure data from a pressure sensor of a pen-type device, record the pressure data as a time-series array, and reproduce a texture of the text data or the image data based on the pressure data.

18. A system comprising:
a communication interface connected to a packet-switched network;
a processor;
a random-access memory;
a memory storing a data generation model, an emotion identification model, a speech recognition model, and an image recognition model;
a database; and
circuitry configured to:
receive, via the communication interface, fingerprint data acquired by a fingerprint sensor of a client terminal connected to the packet-switched network;
authenticate a user by extracting a feature vector from the fingerprint data using a convolutional neural network and computing a cosine similarity between the feature vector and reference data stored in the database;
receive, via the communication interface, text data derived from handwriting recognition performed on pen input acquired by the client terminal;
generate summary data by inputting the text data into the data generation model, the data generation model comprising a Transformer-based large-scale language model;
transmit the summary data to the client terminal via the communication interface to cause display of the summary data on an application interface of the client terminal;
receive, via the communication interface, image data acquired by a camera of the client terminal;
perform content analysis on the image data using the image recognition model to generate tag data;
store the image data and the tag data in the database;
transmit, via the communication interface to a second client terminal associated with another user via a secure communication channel, at least one of the text data or the image data;
receive, via the communication interface, audio data acquired by a microphone of the client terminal;
convert the audio data into converted text data using the speech recognition model; and
assign a timestamp to generated data and associate the timestamp with the feature vector of the user to generate a copyright record stored in the database.

19. The system according to claim 18, wherein the circuitry is further configured to estimate an emotion of the user by inputting at least one of the audio data, facial image data acquired by the camera of the client terminal, or biometric signal data into the emotion identification model, and adjust at least one of a threshold of the authenticating, a length of the summary data, or a display parameter of the application interface based on the estimated emotion.

20. A method performed by circuitry of a system, the method comprising:
authenticating a user by extracting a feature vector from fingerprint data acquired from a fingerprint sensor and comparing the feature vector against stored reference data;
generating summary data by inputting text data, derived from input acquired from the user, into a data generation model;
causing the summary data to be displayed via an application interface;
causing image data, derived from input acquired from the user, to be displayed via the application interface;
transmitting, to a client terminal associated with another user via a communication channel, at least one of the text data or the image data;
converting audio data acquired from a microphone into text data using a speech recognition model; and
performing content analysis on image data acquired from a camera using an image recognition model.
